(19) United States
(12) Patent Application Publication
(10) Pub. No.: US 2024/0056259 A1
(43) Pub. Date: Feb. 15, 2024

(54) PHASE-TRACKING REFERENCE SIGNAL POWER BOOSTING FOR UP TO 8-LAYER UPLINK TRANSMISSIONS

(71) Applicant: QUALCOMM Incorporated, San Diego, CA (US)

(72) Inventors: Yi Huang, San Diego, CA (US); Yu Zhang, San Diego, CA (US); Peter Gaal, San Diego, CA (US); Wanshi Chen, San Diego, CA (US)

(21) Appl. No.: 18/351,941

(22) Filed: Jul. 13, 2023

Related U.S. Application Data
(60) Provisional application No. 63/371,368, filed on Aug. 12, 2022.

(51) Int. Cl. H04L 5/00; H04W 52/32

(52) U.S. Cl. CPC H04L 5/0051; H04W 52/325

(57) ABSTRACT

Techniques related to multi-layer wireless communications are disclosed. Some aspects of the disclosure relate to devices and methods for determining a transmission power boost for a phase-tracking reference signal (PT-RS). A wireless user equipment (UE) may map a multi-layer uplink transmission to a plurality of PT-RS ports by distributing the layers of the multi-layer uplink transmission among the plurality of PT-RS ports. The UE may determine a first transmission power boost for a first PT-RS port, and a second transmission power boost, different from the first transmission power boost, for a second PT-RS port. The UE may transmit a first PT-RS corresponding to the first PT-RS port utilizing the first transmission power boost, and the second PT-RS corresponding to the second PT-RS port, frequency division multiplexed with the first PT-RS, utilizing the second transmission power boost. Other aspects, embodiments, and features are also claimed and described.

This application claims the benefit of U.S. Provisional Patent Application No. 63/371,368, filed Aug. 12, 2022, the entire content of which is incorporated by reference herein.

### TECHNICAL FIELD

The technology discussed below relates generally to wireless communication systems, and more particularly, to multi-layer uplink transmissions. Certain aspects may relate to techniques for enabling and providing communication devices configured to boost a transmission power of a phase-tracking reference signal (PT-RS) in a multi-layer uplink transmission.

### Introduction

Oscillator phase noise typically increases as a function of carrier frequency. Thus, particularly for higher frequencies (e.g., millimeter-wave communications), phase noise can introduce into wireless signals a substantial common phase error, or a common phase rotation of the sub-carriers. A phase-tracking reference signal (PT-RS) enables tracking of the phase of a local oscillator at the UE to compensate for such phase noise.

### BRIEF SUMMARY OF SOME EXAMPLES

The following presents a summary of one or more aspects of the present disclosure, to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later. While some examples may be discussed as including certain aspects or features, all discussed examples may include any of the discussed features. And unless expressly described, no one aspect or feature is essential to achieve technical effects or solutions discussed herein.

In various aspects, a power boost for a phase tracking reference signal (PT-RS) is determined and applied to a multi-layer uplink transmission. In some examples, for a multi-port PTRS transmission, a different power boost may be applied to different PT-RS ports. That is, a wireless user equipment (UE) may separately determine a PT-RS transmission power boost for each of a plurality of PT-RS ports. By virtue of enabling separate power boosts for separate PT-RS ports, a receiving node such as a base station, measuring the PT-RSs, may be better enabled to compensate for phase noise at the UE. By compensating for phase noise, wireless communication with higher data rates may be achieved. Moreover, improved cell capacity and/or spectral efficiency of a cell may be achieved.

In one example a method, apparatus, and non-transitory computer-readable medium for wireless communication is disclosed. A UE may map a multi-layer uplink transmission to a plurality of phase-tracking reference signal (PT-RS) ports, where the mapping includes distributing the layers of the multi-layer uplink transmission among the plurality of PT-RS ports. The UE may further determine a first transmission power boost for a first PT-RS port of the plurality of PT-RS ports. The UE may further determine a second transmission power boost, different from the first transmission power boost, for a second PT-RS port of the plurality of PT-RS ports. The UE may then transmit a first PT-RS corresponding to the first PT-RS port utilizing the first transmission power boost, and transmit a second PT-RSs corresponding to the second PT-RS port, frequency division multiplexed with the first PT-RS, utilizing the second transmission power boost.

In another example a method, apparatus, and non-transitory computer-readable medium for wireless communication is disclosed. A UE may map a multi-layer uplink transmission to a plurality of PT-RS) ports, including distributing layers of the multi-layer uplink transmission among the plurality of PT-RS ports, determine a first transmission power boost for a first PT-RS port of the plurality of PT-RS ports as a function of a quantity of layers of the multi-layer uplink transmission transmitted by physical uplink shared channel (PUSCH) ports mapped to the first PT-RS port and a total number of PT-RS ports associated with the multi-layer uplink transmission, and transmit a first PT-RS corresponding to the first PT-RS port utilizing the first transmission power boost.

These and other aspects of the technology discussed herein will become more fully understood upon a review of the detailed description, which follows. Other aspects and features will become apparent to those of ordinary skill in the art, upon reviewing the following description of specific examples in conjunction with the accompanying figures. While the following description may discuss various advantages and features relative to certain examples, implementations, and figures, all examples can include one or more of the advantageous features discussed herein. In other words, while this description may discuss one or more examples as having certain advantageous features, one or more of such features may also be used in accordance with the other various examples discussed herein. In similar fashion, while this description may discuss certain examples as devices, systems, or methods, it should be understood that such examples of the teachings of the disclosure can be implemented in various devices, systems, and methods.

### BRIEF DESCRIPTION OF THE DRAWINGS

FIG. 1 is a schematic illustration of a wireless communication system according to some aspects of this disclosure.

FIG. 2 is a conceptual illustration of an example of a radio access network according to some aspects of this disclosure.

FIG. 3 is a schematic illustration of a distributed base station in an open radio access network architecture according to some aspects of this disclosure.

FIG. 4 is a conceptual illustration of a user plane protocol stack and a control plane protocol stack according to some aspects of this disclosure.

FIG. 5 is a schematic illustration of an organization of wireless resources in an air interface utilizing orthogonal frequency divisional multiplexing (OFDM) according to some aspects of this disclosure.

FIG. 6 is a block diagram illustrating a wireless communication system supporting multiple-input multiple-output (MIMO) communication according to some aspects of this disclosure.

FIG. 7 is a conceptual illustration of an OFDM symbol including a phase-tracking reference signal (PT-RS) according to some aspects of this disclosure.

FIG. 8 is a table showing a power boost to apply to a PT-RS transmission based on input parameters according to some aspects of this disclosure.

FIG. 9 is a conceptual illustration of port assignments for a multi-panel user equipment according to some aspects of this disclosure.

FIG. 10 is a table showing a power boost to apply to a PT-RS transmission based on input parameters according to some aspects of this disclosure.

FIG. 11 is a conceptual illustration of layer mapping a multi-layer uplink transmission to a plurality of PT-RS ports according to some aspects of this disclosure.

FIG. 12 is a conceptual illustration of another example of layer mapping a multi-layer uplink transmission to a plurality of PT-RS ports according to some aspects of this disclosure.

FIG. 13 is a conceptual illustration of a technique for determining a power boost to apply to a PT-RS transmission according to some aspects of this disclosure.

FIG. 14 is a block diagram conceptually illustrating an example of a hardware implementation for a base station according to some aspects of this disclosure.

FIG. 15 is a block diagram conceptually illustrating an example of a hardware implementation for a user equipment (UE) according to some aspects of this disclosure.

FIG. 16 is a call flow diagram illustrating wireless communication between a user equipment and base station according to some aspects of this disclosure.

FIG. 17 is a flow chart illustrating an example of a process for determining a transmission power boost for a PT-RS transmission according to some aspects of this disclosure.

### DETAILED DESCRIPTION

Oscillator phase noise typically increases as a function of carrier frequency. Thus, particularly for higher frequencies (e.g., FR2, or millimeter-wave communications), phase noise can introduce into orthogonal frequency division multiplexed (OFDM) signals a substantial common phase error, or a common phase rotation of the sub-carriers. A phase-tracking reference signal (PT-RS) enables tracking of the phase of a local oscillator at the UE to compensate for such phase noise. To provide for more robust phase noise compensation, in certain scenarios the power of a PT-RS transmission can be boosted.

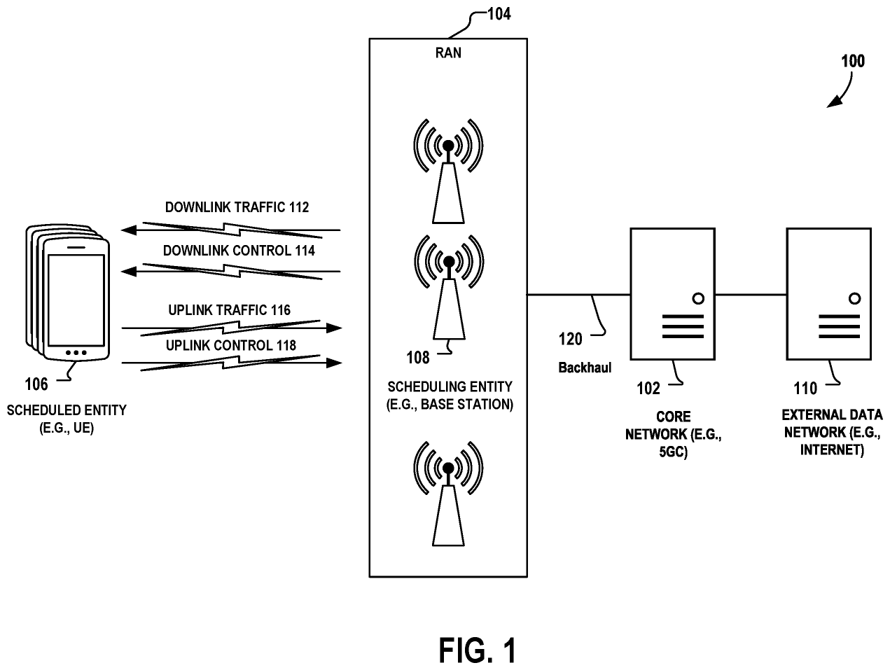

The disclosure that follows presents various concepts that may be implemented across a broad variety of telecommunication systems, network architectures, and communication standards. Referring now to FIG. 1, as an illustrative example without limitation, this schematic illustration shows various aspects of the present disclosure with reference to a wireless communication system 100. The wireless communication system 100 includes several interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G or 5G NR. In some examples, the RAN 104 may operate under a hybrid of 5G NR and Evolved Universal Terrestrial Radio Access Network (eUTRAN) standards, often referred to as Long-Term Evolution (LTE). 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, those skilled in the art may variously refer to a “base station” as a base transceiver station (BTS), a radio base station, a radio transceiver, a transceiver function, a basic service set (BSS), an extended service set (ESS), an access point (AP), a Node B (NB), an evolved Node B (eNB), a gNode B (gNB), a 5G NB, a serving cell, or some other suitable terminology.

The radio access network (RAN) 104 supports wireless communication for multiple mobile apparatuses. Those skilled in the art may refer to a mobile apparatus as a UE, as in 3GPP specifications, but may also refer to a UE as a mobile station (MS), a subscriber station, a mobile unit, a subscriber unit, a wireless unit, a remote unit, a mobile device, a wireless device, a wireless communication device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides access to network services. A UE may take on many forms and can include a range of devices.

Within the present document, a “mobile” apparatus (aka a UE) need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; and agricultural equipment; etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data. A mobile apparatus may additionally include two or more disaggregated devices in communication with one another, including, for example, a wearable device, a haptic sensor, a limb movement sensor, an eye movement sensor, etc., paired with a smartphone. In various examples, such disaggregated devices may communicate directly with one another over any suitable communication channel or interface, or may indirectly communicate with one another over a network (e.g., a local area network or LAN).

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, a scheduling entity may be responsible for scheduling, assigning, reconfiguring, and releasing resources for one or more scheduled entities. That is, for scheduled communication, UEs 106, which may be scheduled entities, may utilize resources allocated by a scheduling entity 108.

Base stations are not the only entities that may function as scheduling entities. That is, in some examples, a UE or network node may function as a scheduling entity, scheduling resources for one or more scheduled entities (e.g., one or more UEs).

As illustrated in FIG. 1, a base station 108 may broadcast downlink traffic 112 to one or more UEs 106. Broadly, the base station 108 is a node or device responsible for scheduling traffic in a wireless communication network, including downlink traffic 112 and, in some examples, uplink traffic 116 from one or more UEs 106 to the base station 108. On the other hand, the UE 106 is a node or device that receives downlink control information 114, including but not limited to scheduling information (e.g., a grant), synchronization or timing information, or other control information from another entity in the wireless communication network such as the base station 108.

In general, base stations 108 may include a backhaul interface for communication with a backhaul portion 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

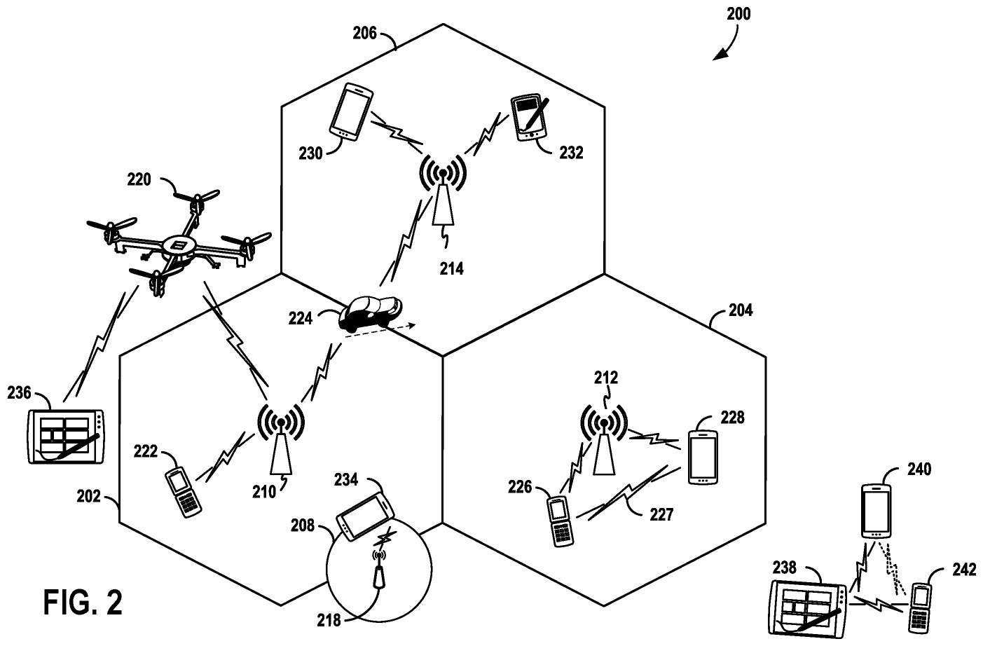

FIG. 2 provides a schematic illustration of a RAN 200, by way of example and without limitation. In some examples, the RAN 200 may be the same as the RAN 104 described above and illustrated in FIG. 1. The geographic area covered by the RAN 200 may be divided into cellular regions (cells) that a user equipment (UE) can uniquely identify based on an identification broadcasted from one base station. FIG. 2 illustrates macrocells 202, 204, and 206, and a small cell 208.

FIG. 2 shows two three base stations 210, and 212, and 214 in cells 202, 204, and 206. In the illustrated example, the cells 202, 204, and 206 may be referred to as macrocells, as the base stations 210, 212, and 214 support cells having a large size. Further, a base station 218 is shown in the small cell 208 (e.g., a microcell, picocell, femtocell, home base station, home Node B, home eNode B, etc.) which may overlap with one or more macrocells. In this example, the cell 208 may be referred to as a small cell, as the base station 218 supports a cell having a relatively small size. Cell sizing can be done according to system design as well as component constraints.

The RAN 200 may include any number of wireless base stations and cells. Further, a RAN may include a relay node to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity 108 described above and illustrated in FIG. 1.

FIG. 2 further includes a quadcopter or drone 220, which may be configured to function as a base station. That is, in some examples, a cell may not necessarily be stationary, and the geographic area of the cell may move according to the location of a mobile base station such as the quadcopter 220.

Within the RAN 200, each base station 210, 212, 214, 218, and 220 may be configured to provide an access point to a core network 102 (see FIG. 1) for all the UEs in the respective cells. For example, UEs 222 and 224 may be in communication with the base station 210; UEs 226 and 228 may be in communication with the base station 212; UEs 230 and 232 may be in communication with the base station 214; UE 234 may be in communication with the base station 218; and UE 236 may be in communication with the mobile base station 220. In some examples, the UEs 222, 224, 226, 228, 230, 232, 234, 236, 238, 240, and/or 242 may be the same as the UE/scheduled entity 106 described above and illustrated in FIG. 1.

In some examples, a mobile node (e.g., quadcopter 220) may be configured to function as a UE. For example, the quadcopter 220 may operate within cell 202 by communicating with base station 210.

In a further aspect of the RAN 200, sidelink signals may be used between UEs without necessarily relying on scheduling or control information from a base station (e.g., a scheduling entity). For example, two or more UEs (e.g., UEs 226 and 228) may communicate with each other using peer to peer (P2P) or sidelink signals 227 without relaying that communication through a base station. In a further example, UE 238 is illustrated communicating with UEs 240 and 242. Here, the UE 238 may function as a scheduling entity or a primary sidelink device, and UEs 240 and 242 may function as a scheduled entity or a non-primary (e.g., secondary) sidelink device. In still another example, a UE may function as a scheduling entity in a device-to-device (D2D), peer-to-peer (P2P), or vehicle-to-vehicle (V2V) network, and/or in a mesh network. In a mesh network example, UEs 240 and 242 may optionally communicate directly with one another in addition to communicating with the scheduling entity 238. Thus, in a wireless communication system with scheduled access to time—frequency resources and having a cellular configuration, a P2P configuration, or a mesh configuration, a scheduling entity and one or more scheduled entities may communicate utilizing the scheduled resources.

The air interface in the RAN 200 may utilize one or more duplexing algorithms. Duplex refers to a point-to-point communication link where both endpoints can communicate with one another in both directions. Full duplex means both endpoints can simultaneously communicate with one another. Half duplex means only one endpoint can send information to the other at a time utilizing a given resource. In a wireless link, a full duplex channel generally relies on physical isolation of a transmitter and receiver, and suitable interference cancellation technologies. Full duplex emulation is frequently implemented for wireless links by utilizing frequency division duplex (FDD) or time division duplex (TDD). In FDD, transmissions in different directions operate at different carrier frequencies. In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot.

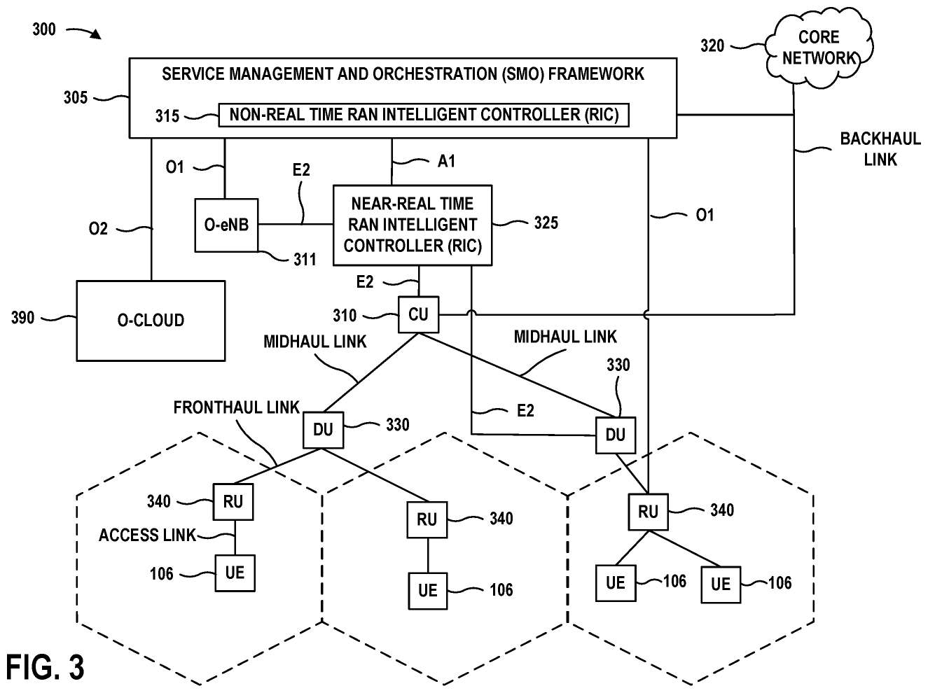

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 106 via one or more radio frequency (RF) access links. In some implementations, the UE 106 may be simultaneously served by multiple RUs 340.

Each of the units, i.e., the CUs 310, the DUs 330, the RUs 340, as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 106. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

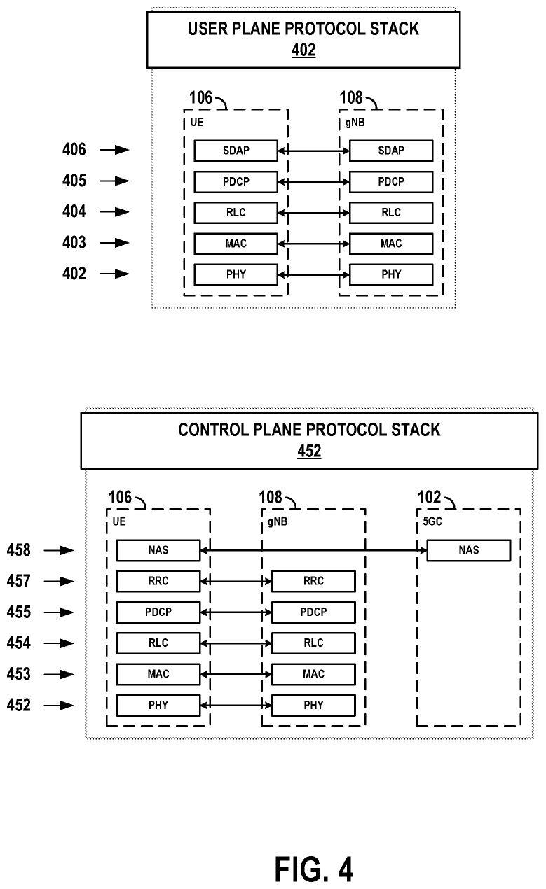

FIG. 4 is a schematic illustration of a user plane protocol stack 402 and a control plane protocol stack 452 in accordance with some aspects of this disclosure. In a wireless telecommunication system, the communication protocol architecture may take on various forms depending on the application. For example, in a 3GPP NR system, the signaling protocol stack is divided into Non-Access Stratum (NAS, 458) and Access Stratum (AS, 402-406 and 452-457) layers and protocols. The NAS protocol 458 provides upper layers, for signaling between a UE 106 and a core network 102 (referring to FIG. 1). The AS protocol 402-406 and 452-457 provides lower layers, for signaling between the RAN 104 (e.g., a gNB or other network node 108) and the UE 106.

Turning to FIG. 4, a radio protocol architecture is illustrated with a user plane protocol stack 402 and a control plane protocol stack 452, showing their respective layers or sublayers. Radio bearers between a network node 108 and a UE 106 may be categorized as data radio bearers (DRB) for carrying user plane data, corresponding to the user plane protocol 402; and signaling radio bearers (SRB) for carrying control plane data, corresponding to the control plane protocol 452.

In the AS, both the user plane 402 and control plane 452 protocols include a physical layer (PHY) 402/452, a medium access control layer (MAC) 403/453, a radio link control layer (RLC) 404/454, and a packet data convergence protocol layer (PDCP) 405/455. PHY 402/452 is the lowest layer and implements various physical layer signal processing functions. The MAC layer 403/453 provides multiplexing between logical and transport channels and is responsible for various functions. For example, the MAC layer 403/453 is responsible for reporting scheduling information, priority handling and prioritization, and error correction through hybrid automatic repeat request (HARQ) operations. The RLC layer 404/454 provides functions such as sequence numbering, segmentation and reassembly of upper layer data packets, and duplicate packet detection. The PDCP layer 405/455 provides functions including header compression for upper layer data packets to reduce radio transmission overhead, security by ciphering the data packets, and integrity protection and verification.

In the user plane protocol stack 402, a service data adaptation protocol (SDAP) layer 406 provides services and functions for maintaining a desired quality of service (QoS). And in the control plane protocol stack 452, a radio resource control (RRC) layer 457 includes a number of functional entities for routing higher layer messages, handling broadcasting and paging functions, establishing and configuring radio bearers, NAS message transfer between NAS and UE, etc.

A NAS protocol layer 458 provides for a wide variety of control functions between the UE 106 and core network 102. These functions include, for example, registration management functionality, connection management functionality, and user plane connection activation and deactivation.

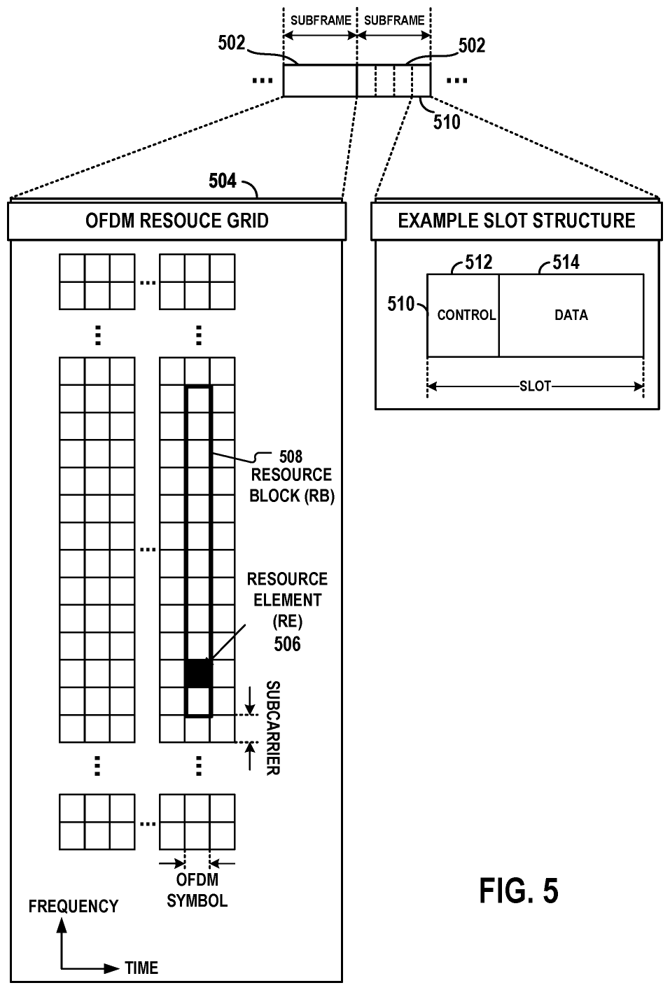

FIG. 5 schematically illustrates various aspects of the present disclosure with reference to an orthogonal frequency divisional multiplexing (OFDM) waveform. Those of ordinary skill in the art should understand that the various aspects of the present disclosure may be applied to a DFT-s-OFDMA waveform in substantially the same way as described herein below. That is, while some examples of the present disclosure may focus on an OFDM link for clarity, it should be understood that the same principles may be applied as well to DFT-s-OFDMA waveforms.

In some examples, a frame may refer to a predetermined duration of time (e.g., 10 ms) for wireless transmissions. And further, each frame may include a set of subframes (e.g., 10 subframes of 1 ms each). A given carrier may include one set of frames in the UL, and another set of frames in the DL. FIG. 5 illustrates an expanded view of an exemplary downlink subframe 502, showing an OFDM resource grid 504. However, as those skilled in the art will readily appreciate, the PHY transmission structure for any application may vary from the example described here, depending on any number of factors. Here, time is in the horizontal direction with units of OFDM symbols; and frequency is in the vertical direction with units of subcarriers or tones.

The resource grid 504 may schematically represent time—frequency resources for a given antenna port. That is, in a multiple-input multiple-output (MIMO) implementation with multiple antenna ports available (described further below), a corresponding multiple number of resource grids 504 may be available for communication. The resource grid 504 is divided into multiple resource elements (REs) 506. An RE, which is 1 subcarrier×1 symbol, is the smallest discrete part of the time—frequency grid and may contain a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 508, which contains any suitable number of consecutive subcarriers in the frequency domain. In one example, an RB may span 12 subcarriers, a number independent of the numerology used. In some examples, depending on the numerology, an RB may include any suitable number of consecutive OFDM symbols in the time domain.

A given UE generally utilizes only a subset of the resource grid 504. An RB may be the smallest unit of resources that a scheduler can allocate to a UE. Thus, the more RBs scheduled for a UE, and the higher the modulation scheme chosen for the air interface, the higher the data rate for the UE.

In this illustration, RB 508 occupies less than the entire bandwidth of the subframe 502, with some subcarriers illustrated above and below the RB 508. In a given implementation, subframe 502 may have a bandwidth corresponding to any number of one or more RBs 508. Further, the RB 508 is shown occupying less than the entire duration of the subframe 502, although this is merely one possible example.

Each 1 ms subframe 502 may include one or multiple adjacent slots. In FIG. 5, one subframe 502 includes four slots 510, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots having a shorter duration (e.g., one or two OFDM symbols). A network node may in some cases transmit these mini-slots occupying resources scheduled for ongoing slot transmissions for the same or for different UEs.

An expanded view of one of the slots 510 illustrates the slot 510 including a control region 512 and a data region 514. In general, the control region 512 may carry control channels (e.g., PDCCH), and the data region 514 may carry data channels (e.g., PDSCH or PUSCH). Of course, a slot may contain all DL, all UL, or at least one DL portion and at least one UL portion. The structure illustrated in FIG. 5 is merely exemplary in nature, and different slot structures may be utilized, and may include one or more of each of the control region(s) and data region(s).

Although not illustrated in FIG. 5, the various REs 506 within an RB 508 may carry one or more physical channels, including control channels, shared channels, data channels, etc. Other REs 506 within the RB 508 may also carry pilots or reference signals. These pilots or reference signals may provide for a receiving device to perform channel estimation of the corresponding channel, which may enable coherent demodulation/detection of the control and/or data channels within the RB 508.

In a downlink transmission, the transmitting device (e.g., a base station 108) may allocate one or more REs 506 (e.g., within a control region 512) to carry one or more downlink control channels. These downlink control channels include downlink control information 114 (DCI) that generally carries information originating from higher layers, such as a physical broadcast channel (PBCH), a physical downlink control channel (PDCCH), etc., to one or more UEs 106. In addition, the network node may allocate one or more downlink REs to carry downlink physical signals that generally do not carry information originating from higher layers. These downlink physical signals may include a primary synchronization signal (PSS); a secondary synchronization signal (SSS); demodulation reference signals (DM-RS); phase-tracking reference signals (PT-RS); channel-state information reference signals (CSI-RS); etc.

A network node may transmit the synchronization signals PSS and SSS (collectively referred to as SS), and in some examples, the PBCH, in an SS block that includes 4 consecutive OFDM symbols. In the frequency domain, the SS block may extend over 240 contiguous subcarriers. Of course, the present disclosure is not limited to this specific SS block configuration. Other nonlimiting examples may utilize greater or fewer than two synchronization signals; may include one or more supplemental channels in addition to the PBCH; may omit a PBCH; and/or may utilize nonconsecutive symbols for an SS block, within the scope of the present disclosure.

The PDCCH may carry downlink control information (DCI) for one or more UEs in a cell. This can include, but is not limited to, power control commands, scheduling information, a grant, and/or an assignment of REs for downlink and uplink transmissions.

In an uplink transmission, a transmitting device (e.g., a UE 106) may utilize one or more REs 506 to carry one or more uplink control channels, such as a physical uplink control channel (PUCCH), a physical random access channel (PRACH), etc. These uplink control channels include uplink control information 118 (UCI) that generally carries information originating from higher layers. Further, uplink REs may carry uplink physical signals that generally do not carry information originating from higher layers, such as demodulation reference signals (DM-RS), phase-tracking reference signals (PT-RS), sounding reference signals (SRS), etc. In some examples, the control information 118 may include a scheduling request (SR), i.e., a request for the network node 108 to schedule uplink transmissions. Here, in response to the SR transmitted on the uplink control channel 118 (e.g., a PUCCH), the network node 108 may transmit downlink control information (DCI) 114 that may schedule resources for uplink packet transmissions.

Uplink control information may also include hybrid automatic repeat request (HARQ) feedback such as an acknowledgment (ACK) or negative acknowledgment (NACK), channel state information (CSI), or any other suitable uplink control information. HARQ is a technique well-known to those of ordinary skill in the art, wherein a receiving device can check the integrity of packet transmissions for accuracy, e.g., utilizing any suitable integrity checking mechanism, such as a checksum or a cyclic redundancy check (CRC). If the receiving device confirms the integrity of the transmission, it may transmit an ACK, whereas if not confirmed, it may transmit a NACK. In response to a NACK, the transmitting device may send a HARQ retransmission, which may implement chase combining, incremental redundancy, etc.

In addition to control information, one or more REs 506 (e.g., within the data region 514) may be allocated for user data or traffic data. Such traffic may be carried on one or more traffic channels, such as, for a downlink transmission, a physical downlink shared channel (PDSCH); or for an uplink transmission, a physical uplink shared channel (PUSCH).

The channels or carriers described above and illustrated in FIGS. 1 and 5 are not necessarily all the channels or carriers that may be utilized between a network node 108 and UE 106, and those of ordinary skill in the art will recognize that other channels or carriers may be utilized in addition to those illustrated, such as other traffic, control, and feedback channels.

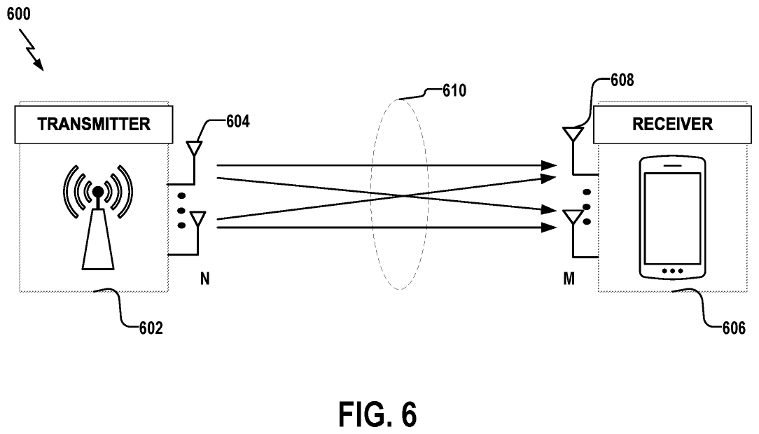

In some aspects of the disclosure, a network node and/or UE may be configured with multiple antennas for beamforming and/or multiple-input multiple-output (MIMO) technology. FIG. 6 illustrates an example of a wireless communication system 600 with multiple antennas, supporting beamforming and/or MIMO. The use of such multiple antenna technology enables the wireless communication system to exploit the spatial domain to support spatial multiplexing, beamforming, and transmit diversity.

Beamforming generally refers to directional signal transmission or reception. For a beamformed transmission, a transmitting device may precode, or control the amplitude and phase of each antenna in an array of antennas to create a desired (e.g., directional) pattern of constructive and destructive interference in the wavefront. In a MIMO system, a transmitter 602 includes multiple transmit antennas 604 (e.g., N transmit antennas) and a receiver 606 includes multiple receive antennas 608 (e.g., M receive antennas). Thus, there are N×M signal paths 610 from the transmit antennas 604 to the receive antennas 608. Each of the transmitter 602 and the receiver 606 may be implemented, for example, within a scheduling entity 108, a scheduled entity 106, or any other suitable wireless communication device.

In a MIMO system, spatial multiplexing may be used to transmit multiple different streams of data, also referred to as layers, simultaneously on the same time-frequency resource. In some examples, a transmitter 602 may send multiple data streams to a single receiver. In this way, a MIMO system takes advantage of capacity gains and/or increased data rates associated with using multiple antennas in rich scattering environments where channel variations can be tracked. Here, the receiver 606 may track these channel variations and provide corresponding feedback to the transmitter 602. In one example case, as shown in FIG. 6, a rank-2 (i.e., including 2 data streams) spatial multiplexing transmission on a 2×2 MIMO antenna configuration will transmit two data streams via two transmit antennas 604. The signal from each transmit antenna 604 reaches each receive antenna 608 along a different signal path 610. The receiver 606 may then reconstruct the data streams using the received signals from each receive antenna 608. The number of data streams or layers in a MIMO or MU-MIMO (generally referred to as MIMO) system corresponds to the rank of the transmission. In general, the rank of a MIMO system is limited by the number of transmit or receive antennas 604 or 608, whichever is lower. In addition, the channel conditions at the receiver 606, as well as other considerations, such as the available resources at the transmitter 602, may also affect the transmission rank. For example, a base station in a RAN (e.g., transmitter 602) may assign a rank (and therefore, a number of data streams) for a DL transmission to a particular UE (e.g., receiver 606) based on a rank indicator (RI) the UE transmits to the base station. The UE may determine this RI based on the antenna configuration (e.g., the number of transmit and receive antennas) and a measured signal-to-interference-and-noise ratio (SINR) on each of the receive antennas. The RI may indicate, for example, the number of layers that the UE may support under the current channel conditions. The base station may use the RI along with resource information (e.g., the available resources and amount of data to be scheduled for the UE) to assign a DL transmission rank to the UE.

The transmitter 602 determines the precoding of the transmitted data stream or streams based, e.g., on known channel state information of the channel on which the transmitter 602 transmits the data stream(s). For example, the transmitter 602 may transmit one or more suitable reference signals (e.g., a channel state information reference signal, or CSI-RS) that the receiver 606 may measure. The receiver 606 may then report measured channel quality information (CQI) back to the transmitter 602. This CQI generally reports the current communication channel quality, and in some examples, a requested transport block size (TBS) for future transmissions to the receiver. In some examples, the receiver 606 may further report a precoding matrix indicator (PMI) to the transmitter 602. This PMI generally reports the receiver's 606 preferred precoding matrix for the transmitter 602 to use, and may be indexed to a predefined codebook. The transmitter 602 may then utilize this CQI/PMI to determine a suitable precoding matrix for transmissions to the receiver 606.

In forthcoming releases of 5G NR, the capability of a UE to transmit uplink MIMO transmissions will be increased from up to 4 layers, to up to 8 layers. That is, 8-layer uplink MIMO is a new feature being standardized. Because of this change, there are further associated features/enhancements possible. Among these is included an uplink power boost for PT-RS transmissions.

### PT-RS

Oscillator phase noise typically increases as a function of carrier frequency. Thus, particularly for higher frequencies (e.g., FR2, or millimeter-wave communications), phase noise can introduce into OFDM signals a substantial common phase error, or a common phase rotation of the sub-carriers. A phase-tracking reference signal (PT-RS) enables tracking of the phase of a local oscillator at the UE to compensate for such phase noise.

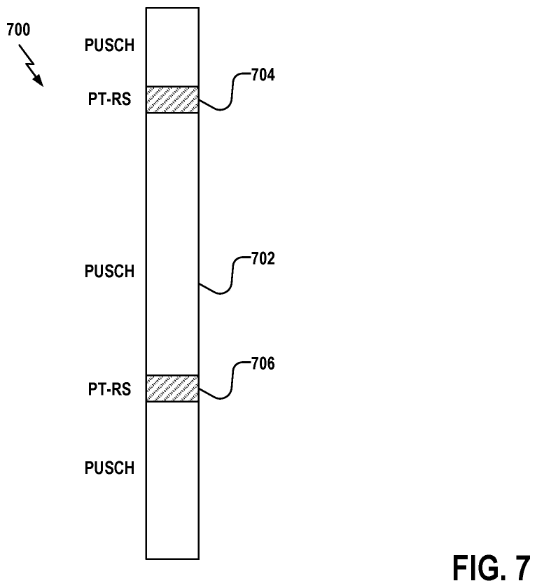

FIG. 7 illustrates an example of an OFDM symbol 700 including two PT-RS tones 704 and 706. A PT-RS is generally a single-layer transmission. That is, each PT-RS tone 704, 706 transmits a single PT-RS port. To transmit multiple PT-RS ports, multiple PT-RS tones 704, 706 are transmitted in a given OFDM symbol 700 using frequency division multiplexing (FDM). For example, a PT-RS may be transmitted in every second resource block (RB), every fourth RB, etc.

Because each PT-RS tone is a single-layer transmission, depending on the precoder a UE uses for PUSCH transmission 702 and on the capability of the UE's power amplifier, the UE may be able to “borrow” power from muted layer(s) on a PT-RS tone. In other words, a single-layer PT-RS tone 704, 706 may receive a power boost depending on the precoder used for the PUSCH transmission 702, and the power amplifier capability of the UE.

The magnitude of the PT-RS power boost depends on several factors. In some examples, one factor is the power amplifier capability of the UE. For example, some UEs may be considered to have (or be configured to have) “small” power amplifiers, where the full power each power amplifier can generate is equal to the quantity: (full power for UE's power class)/(number of transmission layers). Other UEs may be considered to have “large” power amplifiers, where the full power each power amplifier can generate is equal to the full power for the UE's power class. In some examples, configuration of a given UE as having “small” vs. “large” power amplifier capabilities may be configurable by the serving cell. That is, a serving cell may transmit a suitable control message (e.g., an RRC parameter ptrs−Power) that configures a UE for “small” or “large” power amplifier functionality as described above.

According to 3GPP Release-15 Specifications for 5G NR, for a UE where each power amplifier can support full power transmission with respect to the UE's power class (i.e., “large” power amplifier functionality, where ptrs−Power=01), the PT-RS to PUSCH power ratio may be equal to 10 log₁₀ (number of layers). And for a UE where not each power amplifier can support full power transmission with respect to the UE's power class (i.e., “small” power amplifier functionality, where ptrs−Power=00), the PT-RS to PUSCH power ratio may depend on whether the precoder is fully coherent, partially coherent, or noncoherent. Those of ordinary skill in the art will understand the difference between fully coherent, partially coherent, and noncoherent precoders. In short, a precoding matrix represents a weight applied to each antenna (represented by rows of the matrix) for each PUSCH port (represented by columns of the matrix). For fully coherent precoders, all elements in the precoding matrix are nonzero; for noncoherent precoders, each column of the precoding matrix (corresponding to each PUSCH port) has a single nonzero element; and for partially coherent precoders, at least one column of the precoding matrix has two or more nonzero elements (but at least one element in the matrix is equal to zero).

For configurations with a fully coherent precoder, and for configurations with “large” power amplifier functionality (ptrs−Power=01), for any number of PUSCH layers (up to 4 layers), the PT-RS to PUSCH power ratio, in dB, is given as 10 log₁₀ (number of PUSCH layers).

For a noncoherent precoder, for “small” power amplifier functionality (ptrs-Power=00), the PT-RS power ratio, in dB, is 10 log₁₀ (Qₚ), where Qₚ∈{1, 2} represents the number of PT-RS ports with which the UE is configured (up to 2 PT-RS ports).

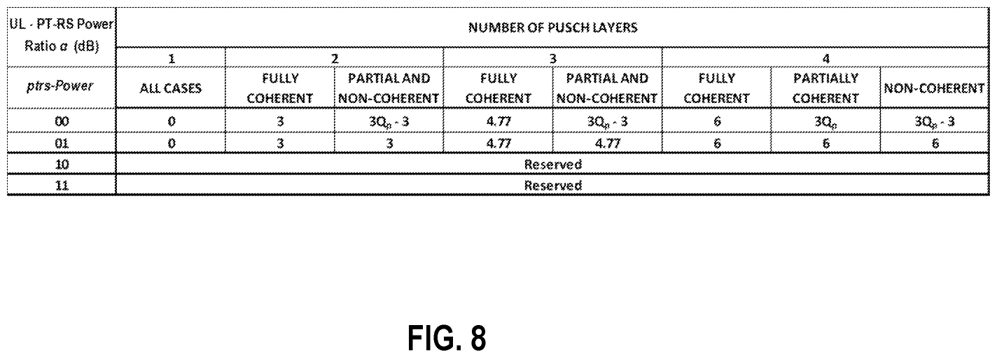

And for a partially coherent precoder, for “small” power amplifier functionality (ptrs−Power=00), the PT-RS to PUSCH power ratio depends on the number of PUSCH layers. If the number of PUSCH layers is 3 or less, then the PT-RS to PUSCH power ratio, in dB, is 10 log₁₀ (Qₚ). While if the number of PUSCH layers is 4, the PT-RS to PUSCH power ratio, in dB, is 10 log₁₀ (Qₚ+3). These values are summarized in the table shown in FIG. 8.

As shown in FIG. 8, for single-layer PUSCH, a PT-RS power boost is unavailable. Thus, the value of the PT-RS power boost is 0 dB for all cases, including “small” and “large” power amplifier functionality. For a multi-layer PUSCH, however (e.g., 2, 3, and 4-layer PUSCH), a PT-RS power boost, borrowing power from muted layers, may be available. For example, for fully coherent precoders, for 2-layer PUSCH, for both “small” and “large” power amplifier functionality, the PT-RS to PUSCH power ratio can be 10 log₁₀ (2)=3 dB. For 3-layer PUSCH, the PT-RS to PUSCH power ratio can be 10 log₁₀ (3)=4.77 dB. And for 4-layer PUSCH, the PT-RS to PUSCH power ratio is 10 log₁₀ (4)=6 dB.

For partially coherent and noncoherent precoders, for 2-layer and 3-layer PUSCH, the PT-RS to PUSCH power ratio can be 10 log₁₀ (Qₚ). For “small” power amplifier functionality, this is illustrated in FIG. 8 as 3Qₚ−3 dB, which is equivalent to 10 log₁₀ (Qₚ) for up to 2 PT-RS ports. And for “large” power amplifier functionality, this is illustrated in FIG. 8 as 3 dB for 2 layers, and 4.77 dB for 3 layers.

And for 4-layer PUSCH, for partially coherent precoders, for “small” power amplifier functionality (ptrs−Power=00), the PT-RS to PUSCH power ratio can be 10 log₁₀ (Qₚ+3). This is illustrated as 3Qₚ dB, which is equivalent to 10 log₁₀ (Qₚ+3) for up to 2 PT-RS ports. And for noncoherent precoders, for “small” power amplifier functionality, the PT-RS to PUSCH power ratio can be 10 log₁₀ (Qₚ), which is equivalent to 3Qₚ−3 dB for up to 2 PT-RS ports.

As mentioned above, later versions of 5G NR (e.g., slated for Release-18 specifications) are being extended from a maximum of 4 layers for uplink MIMO, to up to 8 layers. In various aspects, the present disclosure provides rules for PT-RS power boosting for up to 8-layer PUSCH.

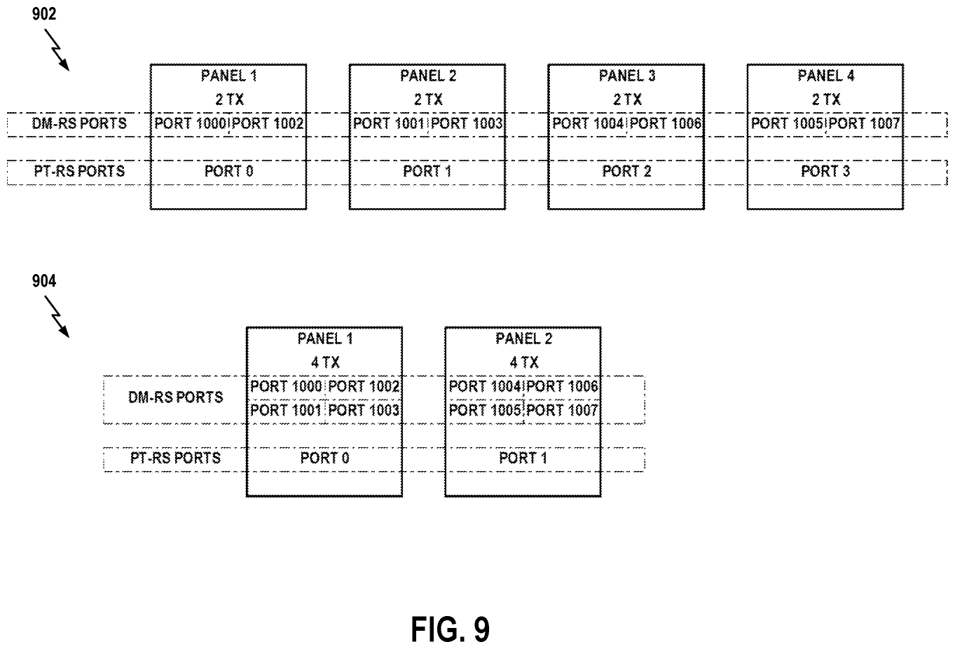

As illustrated in FIG. 9, a UE with the capability to utilize 8-layer PUSCH may have 8 antenna ports. This might be implemented in different UEs, for example, with a set of 4 antenna panels 902 or a set of 2 antenna panels 904. As those of ordinary skill in the art will recognize, in the first example 902 with 4 antenna panels, there may be 4 associated local oscillators, one per antenna panel. Accordingly, in an aspect of the present disclosure, to support 8-layer PUSCH transmissions, the maximum number of PT-RS ports may be increased from 2 to 4. In this way, the PT-RS transmissions can provide compensation for the phase noise from the 4 local oscillators. In the second example 204 with 2 antenna panels, there may be 2 associated local oscillators, one per antenna panel. Accordingly, some devices capable of 8-layer PUSCH may suffice with 2 PT-RS ports.

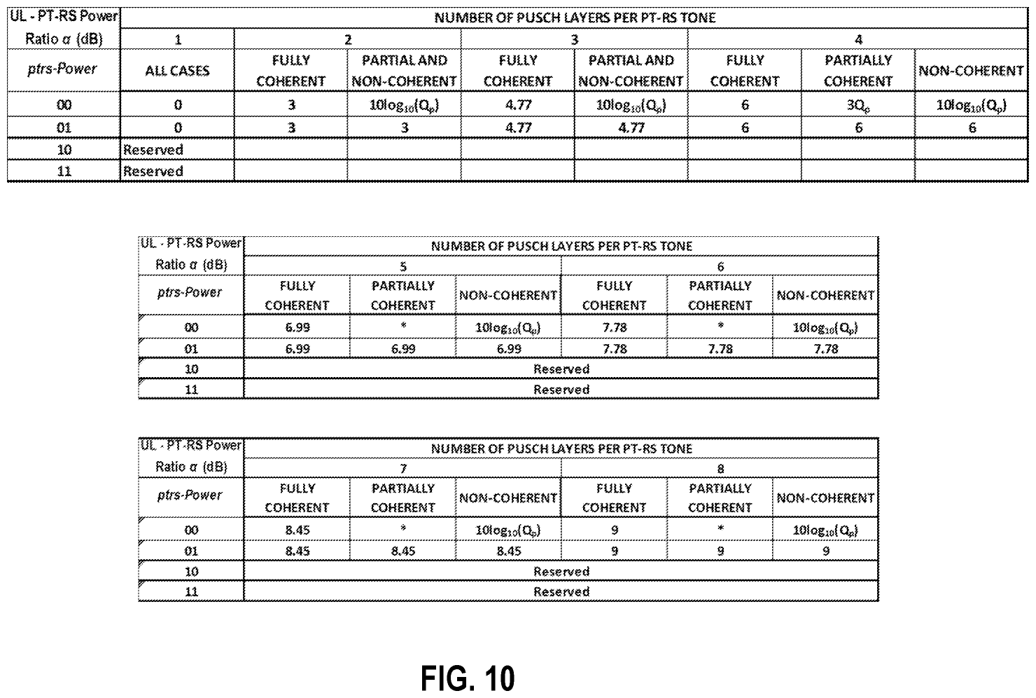

According to an aspect of this disclosure, with 8-layer uplink MIMO, for configurations with a fully coherent precoder, and for configurations with “large” power amplifier functionality (ptrs−Power=01), for any number of PUSCH layers (up to 8 layers), the PT-RS to PUSCH power ratio, in dB, may be 10 log₁₀ (number of PUSCH layers). These values are illustrated in the Table in FIG. 10. That is, FIG. 10 reproduces the table of FIG. 8 for up to 4 PUSCH layers, and is extended up to 8 layers for 8× uplink MIMO.

For configurations with a noncoherent precoder and with a “small” power amplifier functionality (ptrs−Power=00), with up to 8-layer uplink MIMO, the PT-RS to PUSCH power ratio, in dB, may be 10 log₁₀ (Qₚ), where Qₚ∈{1, 2, 3, 4} represents the number of PT-RS ports (up to 4 PT-RS ports). These values are illustrated as 10 log₁₀ (Qₚ) in the Table in FIG. 10.

According to a further aspect of the present disclosure, for configurations with a partially coherent precoder and with a “small” power amplifier functionality (ptrs−Power=00), the PT-RS to PUSCH power ratio may be configured per PT-RS port. That is, the PT-RS to PUSCH power ratio may be different for different PT-RS ports.

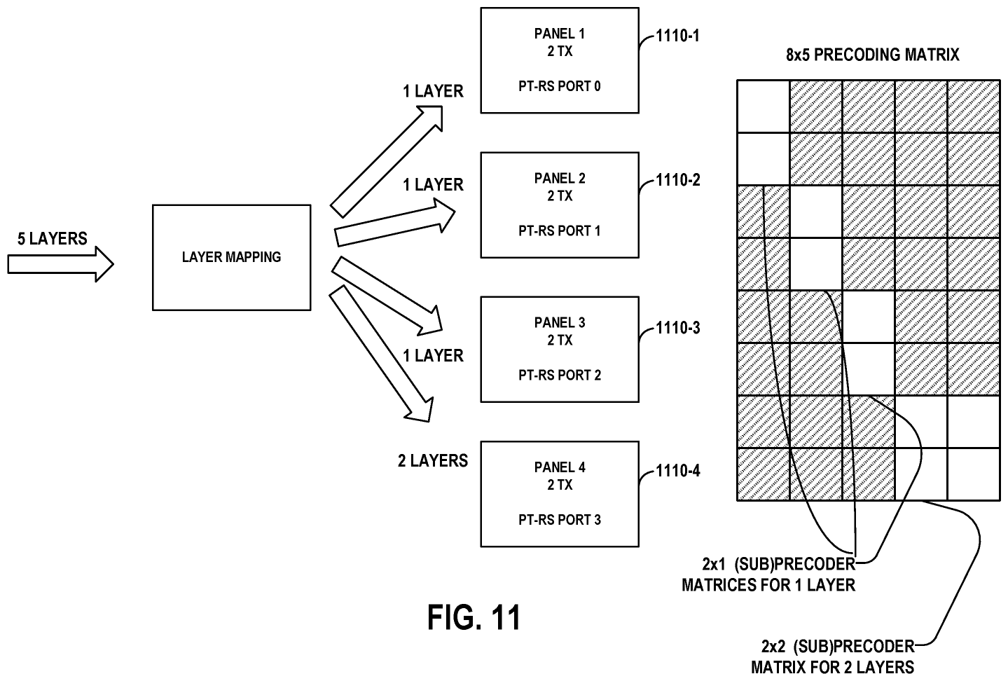

For example, FIG. 11 illustrates one example of layer mapping of 5 PUSCH layers onto 4 PT-RS ports, corresponding to 4 antenna panels, 1110. In the illustrated example, a 5-layer PUSCH is mapped onto the 4 corresponding PT-RS ports, for a UE configured for “small” power amplifiers (ptrs−Power=00). For this example, the precoding matrix is partially coherent. Three of the ports (Ports 0, 1, and 2: 1110-1, 1110-2, and 1110-3) are mapped with one layer, and one of the ports (Port 3: 1110-4) is mapped with 2 layers. According to an aspect of this disclosure, a UE may separately determine the PT-RS power boost for each of the PT-RS ports. For example, referring again to FIG. 10, which illustrates a table showing the PT-RS to PUSCH power ratio for up to 8 PUSCH layers, the UE may separately refer to this table per PT-RS port. Accordingly, for PT-RS ports 0, 1, and 2, which are each mapped with one layer, a PT-RS power boost of 0 dB (i.e., no boost) is available. And for PT-RS port 3, which is mapped with 2 layers, the power boost depends on the 2×2 (sub) precoder matrix for that port 1110-4. If the corresponding 2×2 (sub)precoder is fully coherent, then according to the Table of FIG. 10 the UE may apply a 3 dB power boost to the corresponding PT-RS tone. If the corresponding 2×2 (sub)precoder matrix is partially coherent or noncoherent, then according to the Table of FIG. 10 the UE may apply a boost of 10 log₁₀ (Qₚ) to the corresponding PT-RS tone. Here, because there are Qₚ=4 PT-RS tones, the UE may apply a boost of 10 log₁₀ (4)=6 dB to the corresponding PT-RS tone.

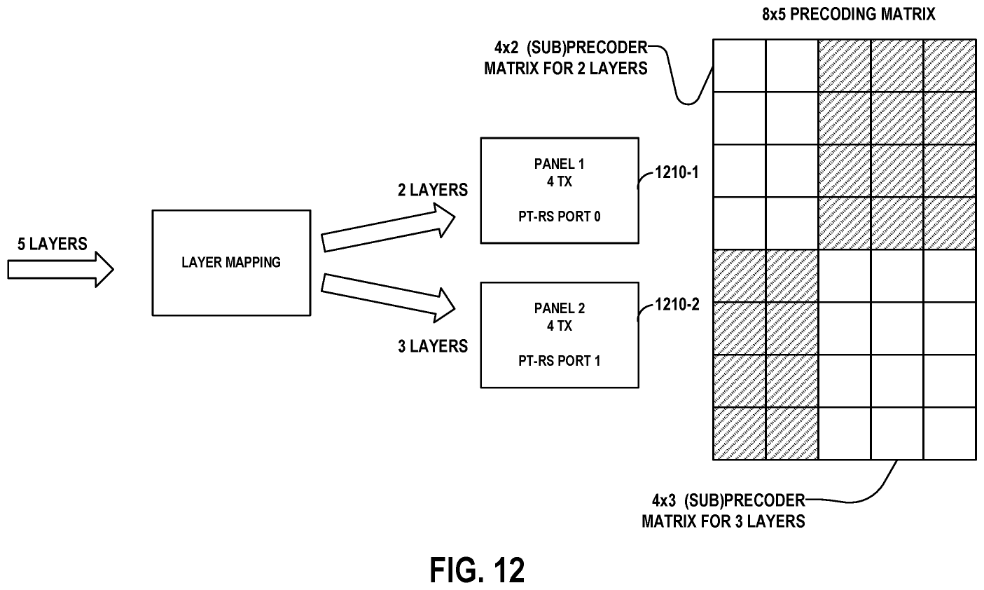

FIG. 12 illustrates another example, mapping 5 PUSCH layers onto 2 PT-RS ports, corresponding to 2 antenna panels 1210. In the illustrated example, a 5-layer PUSCH is mapped onto the 2 corresponding PT-RS ports, for a UE configured with “small” power amplifiers (ptrs−Power=00). For this example, the precoding matrix is partially coherent. One of the ports (Port 0: 1210-1) is mapped with two layers, and one of the ports (Port 1: 1210-2) is mapped with 3 layers. According to an aspect of this disclosure, a UE may separately determine the PT-RS power boost for each of the PT-RS ports. For example, referring again to FIG. 10, the UE may separately refer to this table per PT-RS port. Accordingly, for PT-RS port 0, which is mapped with 2 layers, a PT-RS power boost depends on the 4×2 (sub)precoder matrix for that port 1210-1. If the corresponding 4×2 (sub)precoder is fully coherent, then according to the Table of FIG. 10 the UE may apply a 3 dB power boost to the corresponding PT-RS tone. If the corresponding 4×2 (sub)precoder matrix is partially coherent or noncoherent, then according to the Table of FIG. 10 the UE may apply a boost of 10 log₁₀ (Qₚ)=10 log 10 (2)=3 dB to the corresponding PT-RS tone. And for PT-RS port 1, which is mapped with 3 layers, the power boost also depends on the 4×3 (sub)precoder matrix for that port 1210-2. If the corresponding 4×3 (sub)precoder matrix is fully coherent, then according to the Table of FIG. 10 the UE may apply a boost of 4.77 dB. If the corresponding 4×3 (sub)precoder matrix is partially coherent or noncoherent, then according to the Table of FIG. 10 the UE may apply a boost of 10 log₁₀ (Qₚ)=10 log 10 (2)=3 dB to the corresponding PT-RS tone.

Thus, as shown in the illustrative examples of FIGS. 11 and 12, because the UE may separately determine the PT-RS power boost for each of the PT-RS ports, it follows that the PT-RS power boost for one PT-RS port may differ from the PT-RS power boost for a different PT-RS port.

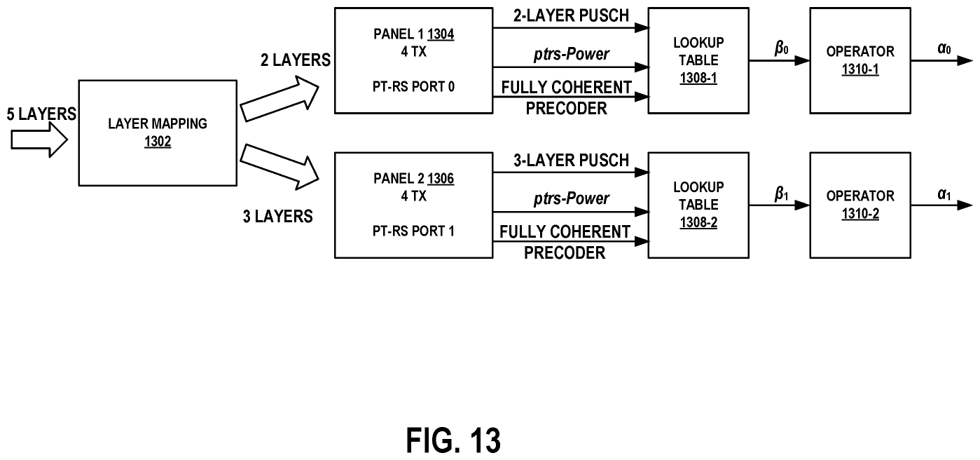

FIG. 13 is a schematic illustration showing detail of a further technique for determining a PT-RS power boost according to a further aspect of this disclosure. In the drawing, for illustrative purposes only, like in FIG. 12, a 5-layer uplink MIMO transmission is mapped to 2 PT-RS ports, corresponding to a 2-panel UE that is capable of 8× uplink MIMO. Of course, in other examples, any suitable number of layers (e.g., up to 8 layers) may be mapped to any suitable number of PT-RS ports (e.g., up to 4 ports). The illustrated example further corresponds to a UE configured for “small” power amplifier functionality (ptrs−Power=00). As in the example of FIG. 12, a layer mapping function 1302 maps 2 layers to panel 1, 1304, and maps 3 layers to panel 2, 1306. In this example, a lookup table 1308 (e.g., as illustrated in FIG. 10) is used to determine a preliminary parameter β, and an operator 1310 is applied to the preliminary parameter β to determine the power boost to apply to the corresponding PT-RS port. Each lookup table 1308 depends on three input parameters in this example: the number of PUSCH layers mapped to the corresponding PT-RS port, the RRC parameter ptrs−Power, and a parameter indicating of the (sub)precoder matrix for the corresponding panel is fully coherent, partially coherent, or noncoherent. Following the example described above in relation to FIG. 12, the first lookup table 1308 takes as inputs a 2-layer PUSCH transmission, a ptrs−Power parameter of 00, and, for example, an indication that the (sub)precoder matrix for the first panel 1304 is a fully coherent precoder (as an example). Accordingly, according to the values in the Table of FIG. 10, the preliminary parameter β for the first lookup table 1308-1 is 3 dB. The second lookup table 1308-2 takes as inputs a 3-layer PUSCH transmission, a ptrs−Power parameter of 00, and, for example, an indication that the (sub)precoder matrix for the second panel 1306 is a fully coherent precoder (as an example). Accordingly, according to the values in the Table of FIG. 10, the preliminary parameter β for the second lookup table 1308-2 is 4.77 dB.

In various examples, any suitable function or operator may be applied by operator block 1310. For example, the operator blocks 1310 may be an identity function, such that α=β. In another example, the operator blocks 1310 may apply a maximum function, where the output value of α is equal to the maximum of the input preliminary parameter β, or some other suitable value that may be configured by the UE. As one example for illustrative purposes, the operator blocks 1310 may apply the function α=max{β, 10 log₁₀ (Qₚ)}. That is, the power boost a to apply to a PT-RS tone is either the value of β or 10 log₁₀ (Qₚ), whichever is greater. Thus, in the example illustrated in FIG. 13 and described above, the first PT-RS boost value α₀=max{β₀, 10 log₁₀ (Qₚ)}=max{3 dB, 3 dB}=3 dB. And the second PT-RS boost value α₁=max{β₁, 10 log₁₀ (Qₚ)}=max{4.77 dB, 3 dB}=4.77 dB.

In another aspect, the operator blocks 1310 may apply a sum function, where the output value of α is equal to the sum of the input preliminary parameter β, and some other suitable value that may be configured by the UE. As one example for illustrative purposes, the operator blocks 1310 may apply the function α=β+10 log₁₀ (Qₚ). That is, the power boost a to apply to a PT-RS tone is the sum of 13 and 10 log₁₀ (Qₚ). Thus, in the example illustrated in FIG. 13 and described above, the first PT-RS boost value α₀=3 dB+3 dB=6 dB. And the second PT-RS boost value α₁=4.77 dB+3 dB=7.77 dB.

This example, where the operator block 1310 is a sum function, can be written in a simplified manner. That is, α=β+10 log₁₀ (Qₚ)=10 log₁₀ (Qₚ*L), where L represents the number of PUSCH layers transmitted by the PUSCH ports mapped to the corresponding PT-RS port. For example, referring again to FIG. 13, there are 2 layers mapped to the first PT-RS port 1304. Thus, the first PT-RS boost value α₀=10 log₁₀ (Qₚ*L), =10 log 10 (2*2)=6 dB. And the second PT-RS boost value al=10 log₁₀ (Qₚ*L), =10 log 10 (2*3)=7.78 dB.

In another aspect, the operator blocks 1310 may apply a minimum function, where the output value of α is equal to the minimum of the sum function described immediately above, or some other suitable parameter that may be configured by the UE. As one illustrative example, the operator blocks 1310 may apply the function α=min {10 log₁₀ (Qₚ*L), 10 log₁₀ (total number of layers of PUSCH)}. That is, the power boost α to apply to a PT-RS tone is either the value of the sum function 10 log₁₀ (Qₚ*L), or 10 log₁₀ (total number of layers of PUSCH), whichever is less. Thus, in the example illustrated in FIG. 13 and described above, the first PT-RS boost value α₀=min{10 log₁₀ (Qₚ*L), 10 log₁₀ (5)}=min{6 dB, 6.99 dB}=6 dB. And the second PT-RS boost value α1=min{10 log₁₀ (Qₚ*L), 10 log 10 (5)}=min{7.78 dB, 6.99 dB}=6.99 dB.

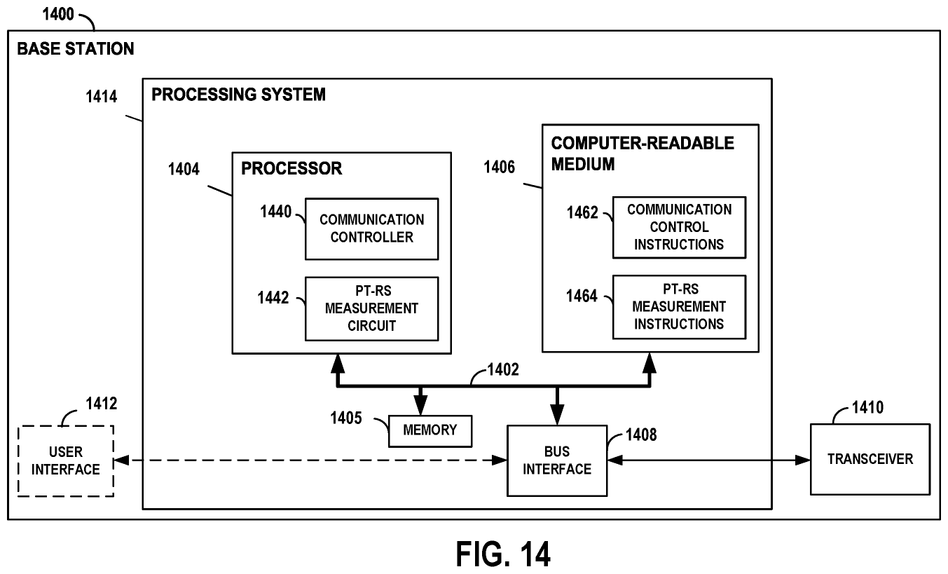

FIG. 14 is a block diagram illustrating an example of a hardware implementation for a base station 1400 employing a processing system 1414. For example, the base station 1400 may be a base station as illustrated in any one or more of FIGS. 1, 2, and/or 3.

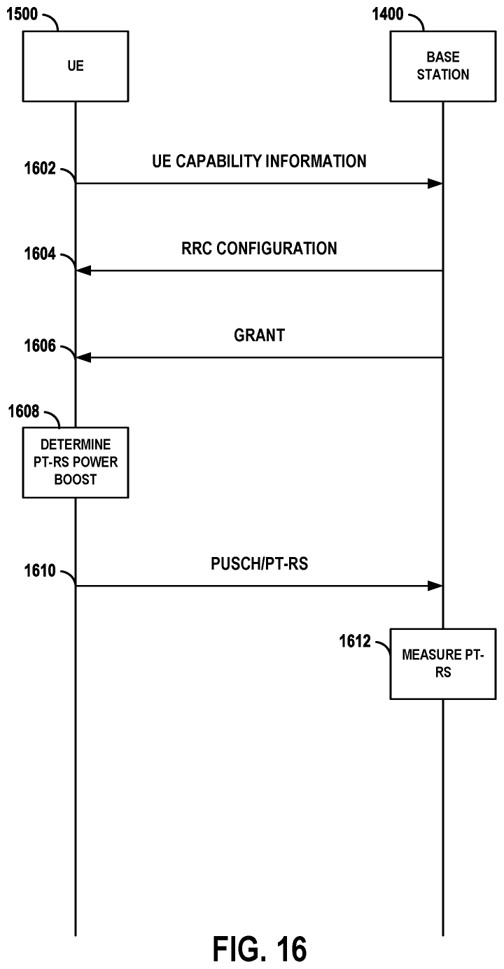

The network node 1400 may include a processing system 1414 having one or more processors 1404. Examples of processors 1404 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the network node 1400 may be configured to perform any one or more of the functions described herein. For example, the processor 1404, as utilized in a network node 1400, may be configured (e.g., in coordination with the memory 1405) to implement any one or more of the processes and procedures described below and illustrated in FIGS. 16 and 114.

The processing system 1414 may be implemented with a bus architecture, represented generally by the bus 1402. The bus 1402 may include any number of interconnecting buses and bridges depending on the specific application of the processing system 1414 and the overall design constraints. The bus 1402 communicatively couples together various circuits including one or more processors (represented generally by the processor 1404), a memory 1405, and computer-readable media (represented generally by the computer-readable medium 1406). The bus 1402 may also link various other circuits such as timing sources, peripherals, voltage regulators, and power management circuits, which are well known in the art, and therefore, will not be described any further. A bus interface 1408 provides an interface between the bus 1402 and a transceiver 1410. The transceiver 1410 provides a communication interface or means for communicating with various other apparatus over a transmission medium. Depending upon the nature of the apparatus, a user interface 1412 (e.g., keypad, display, speaker, microphone, joystick) may also be provided. Of course, such a user interface 1412 is optional, and some examples, such as a base station, may omit it.

In some aspects of the disclosure, the processor 1404 may include communication controller 1440 configured (e.g., in coordination with the memory 1405) for various functions, including, e.g., transmitting and/or receiving user data and/or control signaling to/from a wireless UE. The processor 1404 may further include PT-RS measurement circuitry 1442 configured (e.g., in coordination with the memory 1405) for various functions, including, e.g., measuring one or more PT-RS transmissions and compensating for phase noise at the UE.

The processor 1404 is responsible for managing the bus 1402 and general processing, including the execution of software stored on the computer-readable medium 1406. The software, when executed by the processor 1404, causes the processing system 1414 to perform the various functions described below for any particular apparatus. The processor 1404 may also use the computer-readable medium 1406 and the memory 1405 for storing data that the processor 1404 manipulates when executing software.

One or more processors 1404 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1406. The computer-readable medium 1406 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1406 may reside in the processing system 1414, external to the processing system 1414, or distributed across multiple entities including the processing system 1414. The computer-readable medium 1406 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In one or more examples, the computer-readable storage medium 1406 may store computer-executable code that includes communication control instructions 1462 that configure a base station 1400 for various functions, including, e.g., transmitting and/or receiving user data and/or control signaling to/from a wireless UE. The computer-readable storage medium 1406 may further store computer-executable code that includes PT-RS measurement instructions 1464 that configure a base station 1400 for various functions, including, e.g., measuring one or more PT-RS transmissions and compensating for phase noise at the UE.

Of course, in the above examples, the circuitry included in the processor 1404 is merely provided as an example, and other means for carrying out the described functions may be included within various aspects of the present disclosure, including but not limited to the instructions stored in the computer-readable storage medium 1406, or any other suitable apparatus or means described in any one of the FIGS. 1, 2, and/or 3, and utilizing, for example, the processes and/or algorithms described herein in relation to FIGS. 9 and/or 10.

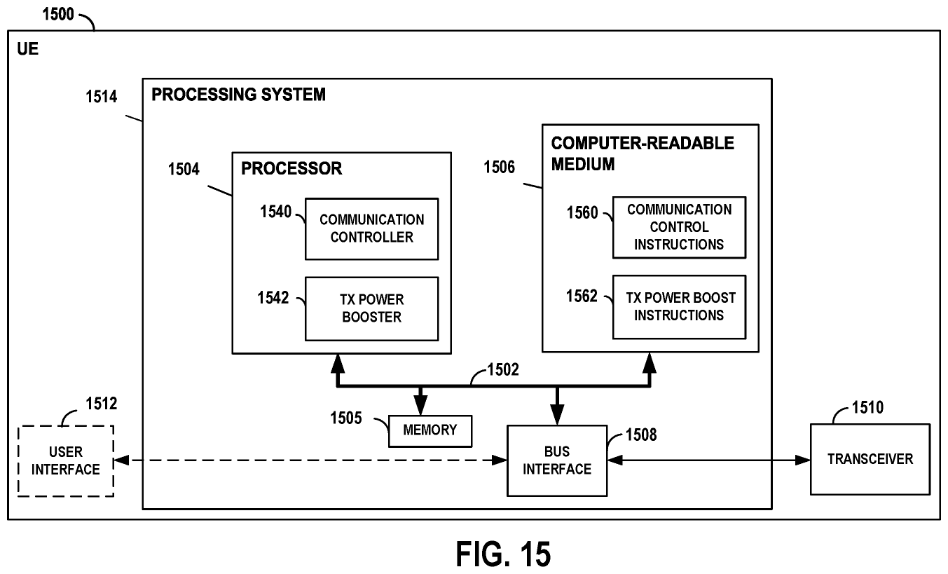

FIG. 15 is a conceptual diagram illustrating an example of a hardware implementation for an exemplary UE 1500 employing a processing system 1514. In accordance with various aspects of the disclosure, a processing system 1514 may include an element, or any portion of an element, or any combination of elements having one or more processors 1504. For example, the UE 1500 may be a user equipment (UE) as illustrated in any one or more of FIGS. 1, 2, and/or 3.

The processing system 1514 may be substantially the same as the processing system 1414 illustrated in FIG. 14, including a bus interface 1508, a bus 1502, memory 1505, a processor 1504, and a computer-readable medium 1506. Furthermore, the UE 1500 may include a user interface 1512 and a transceiver 1510 substantially similar to those described above in FIG. 14.

In some examples, the transceiver 1510 may include multiple antenna panels, each such antenna panel having an associated local oscillator. For example, FIG. 9 schematically illustrates a configuration with four antenna panels and a configuration with two antenna panels. However, the transceiver 1510 may include any suitable number of antenna panels. In further examples, the transceiver 1510 may include multiple power amplifiers that can be configured in accordance with the RRC parameter ptrs−Power. For example, the transceiver 1510 may include a plurality of power amplifiers that, in some examples, may be configured for a “small” or “large” functionality. Here, a “small” power amplifier configuration indicates that the full power that each power amplifier can generate is equal to the quantity: (full power for the UE's power class)/(number of transmission layers). And a “large” power amplifier configuration indicates that the full power that each power amplifier can generate is equal to the full power for the UE's power class.

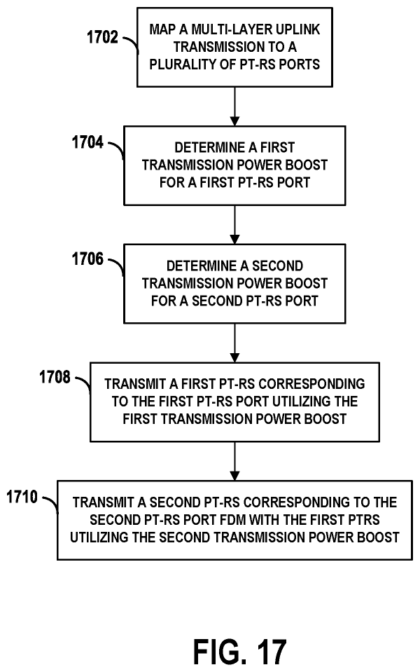

The processor 1504, as utilized in a UE 1500, may be configured (e.g., in coordination with the memory 1505) to implement any one or more of the processes described below and illustrated in FIGS. 16 and 17.

In some aspects of the disclosure, the processor 1504 may include a communication controller 1540 configured (e.g., in coordination with the memory 1505) for various functions, including, for example, transmitting and/or receiving user data and/or control signaling (including reference signals) to/from a base station. The processor 1504 may further include a transmission power booster 1542 configured (e.g., in coordination with the memory 1505) for various functions, including, for example, determining a transmission power boost for a PT-RS port from among a plurality of PT-RS ports. The transmission power booster 1542 may further coordinate with the transceiver 1510 to determine a transmission power for a PT-RS transmission and to transmit the PT-RS.

And further, the computer-readable storage medium 1506 may store computer-executable code that includes communication control instructions 1560 that configure a UE 1500 for various functions, including, e.g., transmitting and/or receiving user data and/or control signaling (including reference signals) to/from a base station. The computer-readable storage medium 1506 may further store computer-executable code that includes transmission power boost instructions 1562 that configure a UE 1500 for various functions, including, e.g., determining a transmission power boost for a PT-RS port from among a plurality of PT-RS ports. The transmission power boost instructions 1562 may further cause the processor 1504 to coordinate with the transceiver 1510 to determine a transmission power for a PT-RS transmission and to transmit the PT-RS.

Of course, in the above examples, the circuitry included in the processor 1504 is merely provided as an example, and other means for carrying out the described functions may be included within various aspects of the present disclosure, including but not limited to the instructions stored in the computer-readable storage medium 1506, or any other suitable apparatus or means described in any one of the FIGS. 1, 2, and/or 3, and utilizing, for example, the processes and/or algorithms described herein in relation to FIGS. 16 and/or 17.

FIG. 16 is a call flow diagram illustrating an exemplary UE 1500 communicating with an exemplary base station 1400 according to an aspect of the disclosure. For purpose of illustration, the UE 1500 may be the same UE 1500 illustrated in FIG. 15, and the base station 1400 may be the same base station 1400 illustrated in FIG. 14.

At any suitable time following establishment of a radio connection, a UE 1500 may communicate a set of UE capability information 1602 to its serving cell. UE capability information 1602 can include a variety of capabilities of the UE 1500. According to an aspect of this disclosure, the UE capability information 1602 may be configured to report a capability to the network indicating power amplifier capabilities of the UE 1500. For example, referring to FIG. 10, a UE 1500 may report whether it is capable of “small” power amplifier functionality (ptrs−Power=00), “large” power amplifier functionality (ptrs−Power=01), or both. This UE capability information 1602 may, in some examples, have per-UE granularity, where one common capability indication applies to all PUSCH layers. In another example, this UE capability information 1602 may have a per-PUSCH layer granularity, where separate capabilities are reported per PUSCH layer, or per subset of PUSCH layers. For instance, a given UE may have capabilities to utilize “large” power amplifier functionality for a subset of PUSCH layers, but may have capabilities only to utilize “small” power amplifier functionality for another subset of PUSCH layers.

At 1604, the base station 1400 may transmit RRC configuration information to the UE 1500. For example, the base station 1400 may provide RRC configuration of the parameter ptrs−Power, which may indicate which row (row 00 for “small” power amplifier functionality or row 01 for “large” power amplifier functionality) to apply in the lookup table. This RRC configuration message 1604 may, in some examples, have per-UE granularity, where one common power amplifier functionality is configured for all PUSCH layers. In another example, this RRC configuration message 1604 may have a per-PUSCH layer granularity, where separate power amplifier functionalities are configured per PUSCH layer, or per subset of PUSCH layers. For instance, a given UE may be configured to utilize “large” power amplifier functionality for a subset of PUSCH layers, but may be configured to utilize “small” power amplifier functionality for another subset of PUSCH layers.

Once the UE 1400 is configured, the network may transmit a grant 1606 to the UE 1500. For example, the grant 1606 may grant or schedule wireless resources for the UE 1500 to utilize for an uplink transmission (e.g., PUSCH). At block 1608, the UE 1500 may determine a transmission power boost for one or more PT-RS ports to be transmitted with the scheduled uplink transmission. For example, the UE 1500 may determine a first transmission power boost for a first PT-RS port, and a second transmission power boost, different from the first transmission power boost, for a second PT-RS port. FIG. 17 is a flow chart showing further detail of a process 1700 for determining a transmission power boost for PT-RS ports according to some aspects of the disclosure. As described below, a particular implementation may omit some or all illustrated features, and may not require some illustrated features to implement all embodiments. In some examples, the UE 1500 illustrated in FIG. 15 may be configured to carry out the process 1700. In some examples, any suitable apparatus or means for carrying out the functions or algorithm described below may carry out the process 1700.

At block 1702, a UE 1500 may map a multi-layer uplink transmission to a plurality of PTRS ports by distributing the layers of the multi-layer uplink transmission among the plurality of PT-RS ports. For example, the communication controller 1540 of the UE 1500 may include a layer mapping function for mapping a multi-layer uplink transmission (e.g., an up to 8-layer uplink MIMO PUSCH transmission) to multiple PT-RS ports corresponding to multiple antenna panels. In various examples, the multi-layer uplink transmission may be distributed in any suitable manner among the multiple PT-RS ports. That is, via the layer mapping function, the same number, or a different number of PUSCH layers may be mapped to respective PT-RS ports.

At block 1704, the UE 1500 may determine a first transmission power boost for a first PT-RS port of the plurality of PT-RS ports. For example, the Tx power booster 1542 of the UE 1500 may reference a lookup table (e.g., the table of FIG. 10) to determine the first transmission power boost. As described above, in some examples, the value determined via the lookup table may depend on several parameters, including: the quantity of PUSCH layers mapped to the corresponding PT-RS port, a power amplifier configuration such as the RRC parameter ptrs−Power (i.e., whether the UE 1500 is configured for “small” or “large” power amplifiers), and the (sub)precoder configuration for the PUSCH layers mapped to the corresponding PT-RS port. In some examples, determining the first transmission power boost may additionally involve applying an operator to the value found by the lookup table, as described above. For example, the first transmission power boost may be the value found by the lookup table, or a predetermined minimum power boost, whichever is greater. In another example, the first transmission power boost may be the value found by the lookup table, summed with a predetermined power boost value. In still another example, the first transmission power boost may be a power boost based on the value found by the lookup table, or a predetermined maximum power boost, whichever is less.

And at block 1706, the UE 1500 may determine a second transmission power boost, different from the first transmission power boost, for a second PT-RS port of the plurality of PT-RS ports. Here, the UE 1500 may determine the second transmission power in the same manner as the first transmission power, with reference to a lookup table and corresponding to the associated PT-RS port. According to an aspect of this disclosure, because the power determination for the second transmission power boost is separate from or independent of the power determination for the first transmission power boost, depending on the values of the parameters input to the lookup table, the second transmission power boost may be different from the first transmission power boost.

Referring also to FIG. 16, the UE may transmit the PUSCH and PT-RSs 1610 utilizing the determined transmission power boosts. That is, at block 1708, the UE 1500 may transmit a first PT-RS corresponding to the first PT-RS port utilizing the first transmission power boost. And at block 1710, the UE 1500 may transmit a second PT-RS corresponding to the second PT-RS port, FDM with the first PT-RS, utilizing the second transmission power boost. For example, the UE 1500 may cause the transceiver 1510 to transmit a multi-layer uplink MIMO transmission with a plurality of PT-RS ports.

Utilizing the PT-RS transmission 1610, at block 1612 the base station 1300 may measure the PT-RSs and compensate for phase noise.

### Further Examples Having a Variety of Features:

Clause 1A: A method, apparatus, and non-transitory computer-readable medium for wireless communication is disclosed. A UE maps a multi-layer uplink transmission to a plurality of phase-tracking reference signal (PT-RS) ports, the mapping comprising distributing the layers of the multi-layer uplink transmission among the plurality of PT-RS ports. The UE further determines a first transmission power boost for a first PT-RS port of the plurality of PT-RS ports. The UE further determines a second transmission power boost, different from the first transmission power boost, for a second PT-RS port of the plurality of PT-RS ports. The UE transmits a first PT-RS corresponding to the first PT-RS port utilizing the first transmission power boost, and transmits a second PT-RSs corresponding to the second PT-RS port, frequency division multiplexed with the first PT-RS, utilizing the second transmission power boost.

Clause 2A: A method, apparatus, and non-transitory computer-readable medium of Clause 1A, wherein determining the first transmission power boost for the first PT-RS port comprises referencing a lookup table to determine the first transmission power boost based on: (1) a quantity of layers of the multi-layer uplink transmission transmitted by the PUSCH ports mapped to the first PT-RS port; (2) a PT-RS power boost configuration; or (3) a first precoder configuration for the layers of the multi-layer uplink transmission transmitted by the PUSCH ports mapped to the first PT-RS port.

Clause 3A: A method, apparatus, and non-transitory computer-readable medium of any of Clauses 1A to 2A, further including applying an operator to a value found by the lookup table.

Clause 4A: The method, apparatus, and non-transitory computer-readable medium of any of Clauses 1A to 3A, wherein the operator is a maximum function returning the value found by the lookup table or a predetermined minimum power boost, whichever is greater.

Clause 5A: The method, apparatus, and non-transitory computer-readable medium Clause 4A, further comprising determining the predetermined minimum power boost based on a quantity of PT-RS ports of the plurality of PT-RS ports of the multi-layer uplink transmission.

Clause 6A: The method, apparatus, and non-transitory computer-readable medium of any of Clauses 1A to 3A, wherein the operator is a summing function returning the value found by the lookup table plus a predetermined power boost value.

Clause 7A: The method, apparatus, and non-transitory computer-readable medium of Clause 6A, further comprising determining the predetermined power boost value based on a total quantity of layers of the multi-layer uplink transmission.

Clause 8A: The method, apparatus, and non-transitory computer-readable medium of any of Clauses 1A to 3A, wherein the operator is a minimum function returning a first value based on the value found by the lookup table, or a maximum power boost, whichever is less.

Clause 9A: The method, apparatus, and non-transitory computer-readable medium of Clause 8A, further comprising determining the maximum power boost based on the total quantity of layers of the multi-layer uplink transmission.

Clause 10A: The method, apparatus, and non-transitory computer-readable medium of any of Clauses 1A to 3A, wherein the operator is the function:

α=min{10 log₁₀Qₚ*Lₚₒᵣₜ,10 log₁₀Lₜₒₜₐₗ}

wherein: a represents the first transmission power boost for the first PT-RS port; Qₚ represents a total number of PT-RS ports associated with the multi-layer uplink transmission; Lₚₒᵣₜ represents a quantity of layers of the multi-layer uplink transmission transmitted by the PUSCH ports mapped to the first PT-RS port; and Lₜₒₜₐₗ represents a total quantity of layers of the multi-layer uplink transmission.

Clause 11A: The method, apparatus, and non-transitory computer-readable medium of any of Clauses 1A to 10A, wherein determining the second transmission power boost for the second PT-RS port comprises referencing the lookup table to determine the second transmission power boost based on: (1) a quantity of layers of the multi-layer uplink transmission transmitted by the PUSCH ports mapped to the second PT-RS port; (2) the PT-RS power boost configuration; or (3) a second precoder configuration for the layers of the multi-layer uplink transmission transmitted by the PUSCH ports mapped to the second PT-RS port.

Clause 12A: The method, apparatus, and non-transitory computer-readable medium of any of clauses 1A to 11A, further comprising transmitting a capability information message indicating a capability to utilize a PT-RS power boost configuration.

Clause 13A: The method, apparatus, and non-transitory computer-readable medium of any of clauses 1A to 12A, wherein the capability information message comprises separate capabilities to utilize the PT-RS power boost configuration for separate layers of the multi-layer uplink transmission.

Clause 14A: The method, apparatus, and non-transitory computer-readable medium of any of clauses 1A to 13A, further comprising receiving a configuration message indicating a PT-RS power boost configuration.

Clause 15A: The method, apparatus, and non-transitory computer-readable medium of any of clauses 1A to 14A, wherein the configuration message comprises separate configurations for the PT-RS power.

Clause 1B: A method of wireless communication comprising: mapping a multi-layer uplink transmission to a plurality of phase-tracking reference signal (PT-RS) ports, the mapping comprising distributing layers of the multi-layer uplink transmission among the plurality of PT-RS ports; determining a first transmission power boost for a first PT-RS port of the plurality of PT-RS ports as a function of a quantity of layers of the multi-layer uplink transmission transmitted by physical uplink shared channel (PUSCH) ports mapped to the first PT-RS port and a total number of PT-RS ports associated with the multi-layer uplink transmission; and transmitting a first PT-RS corresponding to the first PT-RS port utilizing the first transmission power boost.

Clause 2B: The method of Clause 1B, wherein determining the first transmission power boost comprises: determining the first transmission power boost according to the function: α=10 log₁₀ (Qₚ*L), wherein α is the first transmission power boost, Qₚ is the total number of PT-RS ports associated with the multi-layer uplink transmission, and L is the quantity of layers of the multi-layer uplink transmission transmitted by PUSCH ports mapped to the first PT-RS port.

Clause 3B: The method of Clause 1B, wherein determining the first transmission power boost further comprises: determining the first transmission power boost for the first PT-RS port of the plurality of PT-RS ports as the function of the quantity of layers of the multi-layer uplink transmission transmitted by PUSCH ports mapped to the first PT-RS port, the total number of PT-RS ports associated with the multi-layer uplink transmission, and a total quantity of layers of the multi-layer uplink transmission.

Clause 4B: The method of Clause 3B, wherein determining the first transmission power boost comprises: determining the first transmission power boost according to the function: α=min{10 log₁₀ Qₚ*Lₚₒᵣₜ, 10 log₁₀ Lₜₒₜₐₗ}, wherein α is the first transmission power boost, min is a minimum function, Qₚ is total number of PT-RS ports associated with the multi-layer uplink transmission, and Lₚₒᵣₜ is the quantity of layers of the multi-layer uplink transmission transmitted by PUSCH ports mapped to the first PT-RS port, and Lₜₒₜₐₗ is the total quantity of layers of the multi-layer uplink transmission.

Clause 5B: The method of any of Clauses 1B-4B, wherein determining the first transmission power boost for the first PT-RS port further comprises: referencing a lookup table to determine the first transmission power boost based on: the quantity of layers of the multi-layer uplink transmission transmitted by the PUSCH ports mapped to the first PT-RS port; a PT-RS power boost configuration; and a first precoder configuration for the layers of the multi-layer uplink transmission transmitted by the PUSCH ports mapped to the first PT-RS port.

Clause 6B: The method of Clause 5B, further comprising: applying an operator to a value found by the lookup table.

Clause 7B: The method of Clause 6B, wherein the operator is a maximum function returning the value found by the lookup table or a predetermined minimum power boost, whichever is greater.

Clause 8B: The method of Clause 6B, wherein the operator is a summing function returning the value found by the lookup table plus a predetermined power boost value.

Clause 9B: The method of Clause 6B, wherein the operator is a minimum function returning a first value based on the value found by the lookup table, or a maximum power boost, whichever is less.

Clause 10B: The method of any of Clauses 1B-9B, further comprising: determining a second transmission power boost, different from the first transmission power boost, for a second PT-RS port of the plurality of PT-RS ports; and transmitting a second PT-RSs corresponding to the second PT-RS port, frequency division multiplexed with the first PT-RS, utilizing the second transmission power boost.

Clause 11B: The method of any of Clauses 1B-10B, further comprising: transmitting a capability information message indicating a capability to utilize a PT-RS power boost configuration.

Clause 12B: The method of Clause 11B, wherein the capability information message comprises separate capabilities to utilize the PT-RS power boost configuration for separate layers of the multi-layer uplink transmission.

Clause 13B: The method of any of Clauses 1B-12B, further comprising: receiving a configuration message indicating a PT-RS power boost configuration.

Clause 14B: The method of Clause 13B, wherein the configuration message comprises separate configurations for the PT-RS power boost configuration for separate layers of the multi-layer uplink transmission.

Clause 15B: An apparatus configured for wireless communication, the apparatus comprising: one or more memories; and one or more processors coupled to the one or more memories, the one or more processors configured to cause the apparatus to: map a multi-layer uplink transmission to a plurality of phase-tracking reference signal (PT-RS) ports, including distributing layers of the multi-layer uplink transmission among the plurality of PT-RS ports; determine a first transmission power boost for a first PT-RS port of the plurality of PT-RS ports as a function of a quantity of layers of the multi-layer uplink transmission transmitted by physical uplink shared channel (PUSCH) ports mapped to the first PT-RS port and a total number of PT-RS ports associated with the multi-layer uplink transmission; and transmit a first PT-RS corresponding to the first PT-RS port utilizing the first transmission power boost.

Clause 16B: The apparatus of Clause 15B, wherein to determine the first transmission power boost, the one or more processors are further configured to cause the apparatus to: determine the first transmission power boost according to the function: α=10 log₁₀ (Qₚ*L), wherein α is the first transmission power boost, Qₚ is the total number of PT-RS ports associated with the multi-layer uplink transmission, and L is the quantity of layers of the multi-layer uplink transmission transmitted by PUSCH ports mapped to the first PT-RS port.

Clause 17B: The apparatus of Clause 15B, wherein to determine the first transmission power boost, the one or more processors are further configured to cause the apparatus to: determine the first transmission power boost for the first PT-RS port of the plurality of PT-RS ports as the function of the quantity of layers of the multi-layer uplink transmission transmitted by PUSCH ports mapped to the first PT-RS port, the total number of PT-RS ports associated with the multi-layer uplink transmission, and a total quantity of layers of the multi-layer uplink transmission.

Clause 18B: The apparatus of Clause 17B, wherein to determine the first transmission power boost, the one or more processors are further configured to cause the apparatus to: determine the first transmission power boost according to the function: α=min{10 log₁₀ Qₚ*Lₚₒᵣₜ, 10 log₁₀ Lₜₒₜₐₗ}, wherein α is the first transmission power boost, min is a minimum function, Qₚ is total number of PT-RS ports associated with the multi-layer uplink transmission, and Lₚₒᵣₜ is the quantity of layers of the multi-layer uplink transmission transmitted by PUSCH ports mapped to the first PT-RS port, and Lₜₒₜₐₗ is the total quantity of layers of the multi-layer uplink transmission.

Clause 19B: The apparatus of any of Clauses 15B-18B, wherein to determine the first transmission power boost, the one or more processors are further configured to cause the apparatus to: reference a lookup table to determine the first transmission power boost based on: the quantity of layers of the multi-layer uplink transmission transmitted by the PUSCH ports mapped to the first PT-RS port; a PT-RS power boost configuration; and a first precoder configuration for the layers of the multi-layer uplink transmission transmitted by the PUSCH ports mapped to the first PT-RS port.

Clause 20B: The apparatus of Clause 19B, wherein the one or more processors are further configured to cause the apparatus to: apply an operator to a value found by the lookup table.

Clause 21B: The apparatus of Clause 20B, wherein the operator is a maximum function returning the value found by the lookup table or a predetermined minimum power boost, whichever is greater.

Clause 22B: The apparatus of Clause 20B, wherein the operator is a summing function returning the value found by the lookup table plus a predetermined power boost value.

Clause 23B: The apparatus of Clause 20B, wherein the operator is a minimum function returning a first value based on the value found by the lookup table, or a maximum power boost, whichever is less.

Clause 24B: The apparatus of any of Clauses 15B-23B, wherein the one or more processors are further configured to cause the apparatus to: determine a second transmission power boost, different from the first transmission power boost, for a second PT-RS port of the plurality of PT-RS ports; and transmit a second PT-RSs corresponding to the second PT-RS port, frequency division multiplexed with the first PT-RS, utilizing the second transmission power boost.

Clause 25B: The apparatus of any of Clauses 15B-24B, wherein the one or more processors are further configured to cause the apparatus to: transmit a capability information message indicating a capability to utilize a PT-RS power boost configuration.

Clause 26B: The apparatus of Clause 25B, wherein the capability information message comprises separate capabilities to utilize the PT-RS power boost configuration for separate layers of the multi-layer uplink transmission.

Clause 27B: The apparatus of any of Clauses 15B-26B, wherein the one or more processors are further configured to cause the apparatus to: receive a configuration message indicating a PT-RS power boost configuration.

Clause 28B: The apparatus of Clause 27B, wherein the configuration message comprises separate configurations for the PT-RS power boost configuration for separate layers of the multi-layer uplink transmission.

Clause 29B: An apparatus configured for wireless communication, the apparatus comprising: means for mapping a multi-layer uplink transmission to a plurality of phase-tracking reference signal (PT-RS) ports, the means for mapping comprising means for distributing layers of the multi-layer uplink transmission among the plurality of PT-RS ports; means for determining a first transmission power boost for a first PT-RS port of the plurality of PT-RS ports as a function of a quantity of layers of the multi-layer uplink transmission transmitted by physical uplink shared channel (PUSCH) ports mapped to the first PT-RS port and a total number of PT-RS ports associated with the multi-layer uplink transmission; and means for transmitting a first PT-RS corresponding to the first PT-RS port utilizing the first transmission power boost.

Clause 30B: A non-transitory computer-readable storage medium storing instructions that, when executed, cause one or more processors to: map a multi-layer uplink transmission to a plurality of phase-tracking reference signal (PT-RS) ports, including distributing layers of the multi-layer uplink transmission among the plurality of PT-RS ports; determine a first transmission power boost for a first PT-RS port of the plurality of PT-RS ports as a function of a quantity of layers of the multi-layer uplink transmission transmitted by physical uplink shared channel (PUSCH) ports mapped to the first PT-RS port and a total number of PT-RS ports associated with the multi-layer uplink transmission; and transmit a first PT-RS corresponding to the first PT-RS port utilizing the first transmission power boost.

The detailed description set forth above in connection with the appended drawings is intended as a description of various configurations and is not intended to represent the only configurations in which the concepts described herein may be practiced. The detailed description includes specific details for the purpose of providing a thorough understanding of various concepts. However, those skilled in the art will readily recognize that these concepts may be practiced without these specific details. In some instances, this description provides well known structures and components in block diagram form in order to avoid obscuring such concepts.

While this description describes certain aspects and examples with reference to some illustrations, those skilled in the art will understand that additional implementations and use cases may come about in many different arrangements and scenarios. Innovations described herein may be implemented across many differing platform types, devices, systems, shapes, sizes, packaging arrangements. For example, implementations and/or uses may come about via integrated chip (IC) embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may span over a spectrum from chip-level or modular components to non-modular, non-chip-level implementations and further to aggregate, distributed, or original equipment manufacturer (OEM) devices or systems incorporating one or more aspects of the disclosed technology. In some practical settings, devices incorporating described aspects and features may also necessarily include additional components and features for implementation and practice of claimed and described embodiments. For example, transmission and reception of wireless signals includes a number of components for analog and digital purposes (e.g., hardware components including antenna, radio frequency (RF) chains, power amplifiers, modulators, buffer, processor(s), interleaver, adders/summers, etc.). It is intended that the disclosed technology may be practiced in a wide variety of devices, chip-level components, systems, distributed arrangements, end-user devices, etc. of varying sizes, shapes, and constitution.

By way of example, various aspects of this disclosure may be implemented within systems defined by 3GPP, such as fifth-generation New Radio (5G NR), Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

The present disclosure uses the word “exemplary” to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The present disclosure uses the terms “coupled” and/or “communicatively coupled” to refer to a direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The present disclosure uses the terms “circuit” and “circuitry” broadly, to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-17 may be rearranged and/or combined into a single component, step, feature, or function or embodied in several components, steps, or functions. Additional elements, components, steps, and/or functions may also be added without departing from novel features disclosed herein. The apparatus, devices, and/or components illustrated in FIGS. 1-17 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

Applicant provides this description to enable any person skilled in the art to practice the various aspects described herein. Those skilled in the art will readily recognize various modifications to these aspects, and may apply the generic principles defined herein to other aspects. Applicant does not intend the claims to be limited to the aspects shown herein, but to be accorded the full scope consistent with the language of the claims, wherein reference to an element in the singular is not intended to mean “one and only one” unless specifically so stated, but rather “one or more.” Unless specifically stated otherwise, the present disclosure uses the term “some” to refer to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A method of wireless communication comprising:
mapping a multi-layer uplink transmission to a plurality of phase-tracking reference signal (PT-RS) ports, the mapping comprising distributing layers of the multi-layer uplink transmission among the plurality of PT-RS ports;
determining a first transmission power boost for a first PT-RS port of the plurality of PT-RS ports as a function of a quantity of layers of the multi-layer uplink transmission transmitted by physical uplink shared channel (PUSCH) ports mapped to the first PT-RS port and a total number of PT-RS ports associated with the multi-layer uplink transmission; and
transmitting a first PT-RS corresponding to the first PT-RS port utilizing the first transmission power boost.

2. The method of claim 1, wherein determining the first transmission power boost comprises:
determining the first transmission power boost according to the function:
α=10 log₁₀ (Qₚ*L), wherein α is the first transmission power boost, Qₚ is the total number of PT-RS ports associated with the multi-layer uplink transmission, and L is the quantity of layers of the multi-layer uplink transmission transmitted by PUSCH ports mapped to the first PT-RS port.

3. The method of claim 1, wherein determining the first transmission power boost further comprises:
determining the first transmission power boost for the first PT-RS port of the plurality of PT-RS ports as the function of the quantity of layers of the multi-layer uplink transmission transmitted by PUSCH ports mapped to the first PT-RS port, the total number of PT-RS ports associated with the multi-layer uplink transmission, and a total quantity of layers of the multi-layer uplink transmission.

4. The method of claim 3, wherein determining the first transmission power boost comprises:
determining the first transmission power boost according to the function:
α=min{10 log₁₀Qₚ*Lₚₒᵣₜ,10 log₁₀Lₜₒₜₐₗ},
wherein α is the first transmission power boost, min is a minimum function, Qₚ is total number of PT-RS ports associated with the multi-layer uplink transmission, and Lₚₒᵣₜ is the quantity of layers of the multi-layer uplink transmission transmitted by PUSCH ports mapped to the first PT-RS port, and Lₜₒₜₐₗ is the total quantity of layers of the multi-layer uplink transmission.

5. The method of claim 1, wherein determining the first transmission power boost for the first PT-RS port further comprises:
referencing a lookup table to determine the first transmission power boost based on:
the quantity of layers of the multi-layer uplink transmission transmitted by the PUSCH ports mapped to the first PT-RS port;
a PT-RS power boost configuration; and
a first precoder configuration for the layers of the multi-layer uplink transmission transmitted by the PUSCH ports mapped to the first PT-RS port.

6. The method of claim 5, further comprising:
applying an operator to a value found by the lookup table.

7. The method of claim 6, wherein the operator is a maximum function returning the value found by the lookup table or a predetermined minimum power boost, whichever is greater.

8. The method of claim 6, wherein the operator is a summing function returning the value found by the lookup table plus a predetermined power boost value.

9. The method of claim 6, wherein the operator is a minimum function returning a first value based on the value found by the lookup table, or a maximum power boost, whichever is less.

10. The method of claim 1, further comprising:
determining a second transmission power boost, different from the first transmission power boost, for a second PT-RS port of the plurality of PT-RS ports; and
transmitting a second PT-RSs corresponding to the second PT-RS port, frequency division multiplexed with the first PT-RS, utilizing the second transmission power boost.

11. The method of claim 1, further comprising:
transmitting a capability information message indicating a capability to utilize a PT-RS power boost configuration.

12. The method of claim 11, wherein the capability information message comprises separate capabilities to utilize the PT-RS power boost configuration for separate layers of the multi-layer uplink transmission.

13. The method of claim 1, further comprising:
receiving a configuration message indicating a PT-RS power boost configuration.

14. The method of claim 13, wherein the configuration message comprises separate configurations for the PT-RS power boost configuration for separate layers of the multi-layer uplink transmission.

15. An apparatus configured for wireless communication, the apparatus comprising:
one or more memories; and
one or more processors coupled to the one or more memories, the one or more processors configured to cause the apparatus to:
map a multi-layer uplink transmission to a plurality of phase-tracking reference signal (PT-RS) ports, including distributing layers of the multi-layer uplink transmission among the plurality of PT-RS ports;
determine a first transmission power boost for a first PT-RS port of the plurality of PT-RS ports as a function of a quantity of layers of the multi-layer uplink transmission transmitted by physical uplink shared channel (PUSCH) ports mapped to the first PT-RS port and a total number of PT-RS ports associated with the multi-layer uplink transmission; and
transmit a first PT-RS corresponding to the first PT-RS port utilizing the first transmission power boost.

16. The apparatus of claim 15, wherein to determine the first transmission power boost, the one or more processors are further configured to cause the apparatus to:
determine the first transmission power boost according to the function:
α=10 log₁₀ (Qₚ*L), wherein α is the first transmission power boost, Qₚ is the total number of PT-RS ports associated with the multi-layer uplink transmission, and L is the quantity of layers of the multi-layer uplink transmission transmitted by PUSCH ports mapped to the first PT-RS port.

17. The apparatus of claim 15, wherein to determine the first transmission power boost, the one or more processors are further configured to cause the apparatus to:
determine the first transmission power boost for the first PT-RS port of the plurality of PT-RS ports as the function of the quantity of layers of the multi-layer uplink transmission transmitted by PUSCH ports mapped to the first PT-RS port, the total number of PT-RS ports associated with the multi-layer uplink transmission, and a total quantity of layers of the multi-layer uplink transmission.

18. The apparatus of claim 17, wherein to determine the first transmission power boost, the one or more processors are further configured to cause the apparatus to:
determine the first transmission power boost according to the function:
α=min{10 log₁₀Qₚ*Lₚₒᵣₜ,10 log₁₀Lₜₒₜₐₗ},
wherein α is the first transmission power boost, min is a minimum function, Qₚ is total number of PT-RS ports associated with the multi-layer uplink transmission, and Lₚₒᵣₜ is the quantity of layers of the multi-layer uplink transmission transmitted by PUSCH ports mapped to the first PT-RS port, and Lₜₒₜₐₗ is the total quantity of layers of the multi-layer uplink transmission.

19. The apparatus of claim 15, wherein to determine the first transmission power boost, the one or more processors are further configured to cause the apparatus to:
reference a lookup table to determine the first transmission power boost based on:
the quantity of layers of the multi-layer uplink transmission transmitted by the PUSCH ports mapped to the first PT-RS port;
a PT-RS power boost configuration; and
a first precoder configuration for the layers of the multi-layer uplink transmission transmitted by the PUSCH ports mapped to the first PT-RS port.

20. The apparatus of claim 19, wherein the one or more processors are further configured to cause the apparatus to:
apply an operator to a value found by the lookup table.

21. The apparatus of claim 20, wherein the operator is a maximum function returning the value found by the lookup table or a predetermined minimum power boost, whichever is greater.

22. The apparatus of claim 20, wherein the operator is a summing function returning the value found by the lookup table plus a predetermined power boost value.

23. The apparatus of claim 20, wherein the operator is a minimum function returning a first value based on the value found by the lookup table, or a maximum power boost, whichever is less.

24. The apparatus of claim 15, wherein the one or more processors are further configured to cause the apparatus to:
determine a second transmission power boost, different from the first transmission power boost, for a second PT-RS port of the plurality of PT-RS ports; and
transmit a second PT-RSs corresponding to the second PT-RS port, frequency division multiplexed with the first PT-RS, utilizing the second transmission power boost.

25. The apparatus of claim 15, wherein the one or more processors are further configured to cause the apparatus to:
transmit a capability information message indicating a capability to utilize a PT-RS power boost configuration.

26. The apparatus of claim 25, wherein the capability information message comprises separate capabilities to utilize the PT-RS power boost configuration for separate layers of the multi-layer uplink transmission.

27. The apparatus of claim 15, wherein the one or more processors are further configured to cause the apparatus to:
receive a configuration message indicating a PT-RS power boost configuration.

28. The apparatus of claim 27, wherein the configuration message comprises separate configurations for the PT-RS power boost configuration for separate layers of the multi-layer uplink transmission.

29. An apparatus configured for wireless communication, the apparatus comprising:
means for mapping a multi-layer uplink transmission to a plurality of phase-tracking reference signal (PT-RS) ports, the means for mapping comprising means for distributing layers of the multi-layer uplink transmission among the plurality of PT-RS ports;
means for determining a first transmission power boost for a first PT-RS port of the plurality of PT-RS ports as a function of a quantity of layers of the multi-layer uplink transmission transmitted by physical uplink shared channel (PUSCH) ports mapped to the first PT-RS port and a total number of PT-RS ports associated with the multi-layer uplink transmission; and
means for transmitting a first PT-RS corresponding to the first PT-RS port utilizing the first transmission power boost.

30. A non-transitory computer-readable storage medium storing instructions that, when executed, cause one or more processors to:
map a multi-layer uplink transmission to a plurality of phase-tracking reference signal (PT-RS) ports, including distributing layers of the multi-layer uplink transmission among the plurality of PT-RS ports;
determine a first transmission power boost for a first PT-RS port of the plurality of PT-RS ports as a function of a quantity of layers of the multi-layer uplink transmission transmitted by physical uplink shared channel (PUSCH) ports mapped to the first PT-RS port and a total number of PT-RS ports associated with the multi-layer uplink transmission; and
transmit a first PT-RS corresponding to the first PT-RS port utilizing the first transmission power boost.
